(19) United States
(12) Patent Application Publication
(10) Pub. No.: US 2016/0039312 A1
(43) Pub. Date: Feb. 11, 2016

(54) TRACTION CONTROL DEVICE AND TRACTION CONTROL METHOD

(71) Applicant: PIONEER CORPORATION, Kawasaki-shi, Kanagawa (JP)

(72) Inventor: Masahiro KATO, Kanagawa (JP)

(73) Assignee: PIONEER CORPORATION, Kawasaki-shi, Kanagawa (JP)

(21) Appl. No.: 14/781,684

(22) PCT Filed: Apr. 1, 2013
(86) PCT No.: PCT/JP2013/059954

§ 371 Date: Oct. 1, 2015

(51) Int. Cl. B60L 15/20; B60L 3/12; B60L 15/02

(52) U.S. Cl. CPC B60L 15/20; B60L 15/025; B60L 3/12

(57) ABSTRACT

The movement speed v of a moving body having driving wheels driven by a motor, the rotational speed ω of the drive wheels of the moving body, and the actual torque value Tm generated by the motor are acquired. Subsequently, a limiting part calculates an estimated slip ratio λ and an estimated driving torque T_{d} on the basis of the movement speed v, the rotational speed ω and the actual torque value Tₘ. Next, the limiting part, after calculating a limit value L on the basis of the estimated slip ratio λ and estimated driving torque T_{d}, uses the limit value L to calculate a limited torque value T_{L}. Further, with an adhesive model as the reference model, a feedback part calculates a feedback torque value T_{f} on the basis of the rotational speed ω and the actual torque value Tₘ.

### TECHNICAL FIELD

The present invention relates to a traction control device, to a traction control method and to a traction control program, and to a recording medium upon which that traction control program is recorded.

### BACKGROUND ART

In recent years, from the standpoint of the burden upon the environment and so on, attention is being directed to electric automobiles of types that perform driving and braking with an electric motor according to the amount that an accelerator pedal or a brake pedal is stepped upon. Here, since the electric motor is an electrical component, accordingly the responsiveness and the linearity of driving and of braking for such an electric automobile are outstandingly excellent, as compared to those of an automobile equipped with an internal combustion engine for performing driving and braking by using both of the engine and a hydraulic braking mechanism.

This is because the response speed of an electric motor is around ten times faster than that of a hydraulic mechanism, and is around a hundred times faster than that of an internal combustion engine. Moreover, the relationship between the actual torque value Tₘ generated by an electric motor and the value Iₘ of the current to the motor (hereinafter also sometimes termed the “drive current value”) is given by the following Equation (1):

Tₘ=Kₜ·Iₘ (1)

Here, the torque constant Kₜ may be obtained in advance by measurement. Note that, depending on the type of the motor, the torque constant Kₜ may be fixed or variable according to the motor current value Iₘ or according to the rotational speed. Therefore, the actual torque value Tₘ is accurately ascertained by detecting the motor current value Iₘ with a current sensor or the like during the operation of the electric motor. Moreover, the actual torque value Tₘ is easily controlled by controlling the motor current value Iₘ. Due to this, techniques of various types have been proposed for an electric automobile in order to implement traction control whose levels of safety and of comfort are high as compared to that of an internal combustion engine or via control of brake hydraulic pressure.

As the first example of such a proposed technique, there is mentioned the technique for detecting the slip ratio λ and the friction coefficient μ during vehicle travel, and for controlling the range over which the driving torque of the electric motor increases and decreases on the basis of the slip ratio λ and the friction coefficient n that have thus been detected (refer to Patent Document #1, hereinafter termed the “prior art 1”). With the technique of the prior art 1, the state of the road surface upon which the vehicle is traveling is ascertained by calculating the average value of the ratio of the friction coefficient μ to the slip ratio λ. And the increase or decrease of the driving torque is restricted, when the road surface is one upon which slippage can easily occur.

As the second example of the proposed technique, there is mentioned the technique to restrict the requested torque by performing (i) to obtain the slip ratio λ and the friction coefficient n during traveling by calculation; and (ii) to calculate a maximal driving torque on the basis of the maximal friction coefficient as estimated from the slip ratios λ and the coefficients of friction μ thus calculated (refer to Patent Document #2, hereinafter termed the “prior art 2”). With the technique of the prior art 2, the maximal friction coefficient is estimated by selecting a μ-λ characteristic curve for the road surface upon which the vehicle is traveling on the basis of the correlation between the slip ratios λ and the friction coefficients μ that have been calculated up until the present time point.

As the third example of a proposed technique, there is mentioned the technique for restricting the driving torque on the basis of the permitted maximal torque derived by performing: (i) estimation of the slip ratio λ and the driving torque T during traveling; (ii) estimation of the friction coefficient μ on the basis of this slip ratio λ and this driving torque T that have thus been estimated; and (iii) derivation of a permitted maximal torque for this friction coefficient μ that has thus been estimated and for the current load in the vertical direction sequentially (refer to Patent Document #3, hereinafter termed as the “prior art 3”). With the technique of the prior art 3, the permitted maximal torque is obtained by estimating the friction coefficient μ by referring to the first table that gives the relationship between the slip ratio λ and the driving torque T, and the friction coefficient μ, and by also referring to the second table that gives the relationship between the friction coefficient μ and the permitted maximal torque for each value of the load in the vertical direction.

### PRIOR ART DOCUMENTS

### Patent Documents

Patent Document #1: Japanese Laid-Open Patent Publication 2006-034012.

Patent Document #2: Japanese Laid-Open Patent Publication 2008-167624.

Patent Document #3: Japanese Laid-Open Patent Publication 2012-186928.

### SUMMARY OF INVENTION

### Problems to be Solved by the Invention

The motion of each of the driving wheels of a vehicle that is traveling upon a road surface can be expressed in terms of a single wheel model (hereinafter also sometimes termed a “driving wheel model”). The variables in the driving wheel model are shown in FIG. 1. In FIG. 1, “M” is the weight of the moving body, “F_{d}” is the driving force of the driving wheel WH, and “F_{dr}” is the traveling resistance. Moreover, “Tₘ” is the actual torque value that is generated by the motor and that is applied to the driving wheel WH, “v” is the speed at which the moving body MV is moving (hereinafter termed the “speed of the vehicle” or the “vehicle speed”), and “ωw” is the rotational speed of the driving wheel WH. Furthermore, “N” is the normal reaction force acting upon the driving wheel WH, and “r” is the radius of the driving wheel WH.

In the driving wheel model shown in FIG. 1, the equation of motion of the moving body MV is given by the following Equation (2):

M·(dv/dt)=F_{d}−F_{dr} (2)

Moreover, if the moment of inertia of the driving wheel WH is termed “J_{w}” and the driving torque is termed “T_{d}”, then the equation of motion of the driving wheel WH is given by the following Equation (3):

J_{w}·(dω/dt)=Tₘ−r·F_{d}=Kₜ·Iₘ−T_{d} (3)

If the friction coefficient of the driving wheel WH upon the road surface is termed μ, then the relationship between the driving force F_{d} and the normal reaction force N is given by the following Equation (4):

μ=F_{d}/N (4)

Furthermore, in the driving wheel model described above, the slip ratio λ is given by the following Equation (5):

λ=(r·ω−v)/Max(r·ω, v) (5)

Here, Max(r·ω, v) means the one of r·ω and v whose numerical value is the greater. During driving, Max(r·ω, v) =r·ω, because (r·ω) is greater than v. On the other hand, during braking, Max(r·ω, v)=v, because v is greater than (r·ω).

In the driving wheel model, the relationship between the friction coefficient of μ and the slip ratio λ (in other words, the characteristic) during driving is generally as shown in FIG. 2. Note that, in FIG. 2, the μ-λ characteristic upon a dry road surface is shown by the solid line, that upon a wet road surface is shown by the single dashed broken line, and that upon a frozen road surface is shown by the double dashed broken line.

In the changes of the friction coefficient μ along with increase of the slip ratio during driving shown in FIG. 2, the moving body MV can travel in a stable manner, when the slip ratio is less than or equal to the slip ratio at which the friction coefficient μ becomes maximal (hereinafter, this will be termed a “stable state”). In contrast, the phenomenon of free spinning or the phenomenon of locking of the driving wheel WH can occur, when slip ratio is greater than the slip ratio at which the friction coefficient μ becomes maximal is a state in which (hereinafter this will be termed an “unstable state”). In the following, the region in which the state is stable will be termed the “stable region”, while the region in which the state is unstable will be termed the “unstable region”.

Note that, in changes of the friction coefficient n along with increase of the slip ratio during braking, the stable state is that the slip ratio is greater than or equal to the slip ratio at which the friction coefficient μ becomes minimal. In contrast, the unstable state is that the slip ratio is less than the slip ratio at which the friction coefficient μ becomes minimal.

Cases will now be considered in which, in the case of a road surface having such types of μ-λ characteristic, a vehicle progresses from a dry road surface to a frozen road surface and then back to a dry road surface. In this type of case, the results of simulations when a torque command value T_{c} that corresponds to the amount by which the accelerator pedal is stepped upon is inputted just as it is without modification to the motor drive system as a torque setting value Tₛ are shown in FIGS. 3 and 4. These FIGS. 3 and 4 show the simulation results of the vehicle speed v, the wheel speed (r·ω), the slip ratio λ, and the friction coefficient μ.

Note that the conditions employed for the above simulations were that: the electric automobile was a four wheel drive vehicle; its weight was 1800 [kg]; the moment of inertia of the driving wheel WH was 1.2 [kg·m²]; and the torque response of the motor was 5 [ms] (the case of an in-wheel motor was assumed). Moreover, the simulations were performed under the assumption that the road surface changed from dry to frozen at the time point t₁, and changed back from frozen to dry at the time point t₂ (>t₁).

As shown overall in FIGS. 3 and 4, when the torque command value T_{c} is used as the torque setting value Tₛ just as it is without modification, then the slip ratio λ upon the frozen road surface becomes greater along with increase of the torque setting value Tₛ (=T_{c}). And, when the torque setting value Tₛ (=T_{c}) becomes greater than a specific value, then the slip ratio λ increases. When the torque setting value Tₛ becomes 0.2 or greater, the system enters unstable region shown in FIG. 2 described above, which is undesirable. This shows that, since the friction coefficient μ is small on a frozen road surface, accordingly the gripping force is also low, and the system enters the unstable region when the torque setting value Tₛ undesirably reaches a level that exceeds the gripping force.

In order to avoid the occurrence of this sort of situation in which the system undesirably enters into the unstable region, a method may be contemplated of limiting the torque setting value Tₛ by performing some type of limitation processing upon the torque command value T_{c}. Methods of this type are employed in the techniques of the prior arts 1 to 3. In other words, the techniques the entire prior arts 1 to 3 are methods in which the torque setting value Tₛ upon a frozen road surface is limited by controlling the torque setting value Tₛ be variable according to the estimation result of the state of the road surface, i.e. the λ-μ characteristic, while upon a dry road surface the torque setting value Tₛ is not limited more than necessary.

However, with the techniques of the prior arts 1 to 3, in order to estimate the λ-μ characteristic, averaging processing is performed (in the prior art 1), or estimation processing by the least-square method is performed (in the prior art 2), or table matching processing is performed (in the prior art 3). Therefore, it is necessary to employ a plurality type of data, accordingly a time period of at least around several seconds is required until appropriate limitation is imposed upon the torque setting value Tₛ. Due to this, it is impossible to impose appropriate limitation upon the torque setting value Tₛ rapidly, when the state of the road surface has changed. As a result, it is difficult to say that it enable to ensure safety rapidly when a change from a dry road surface to a frozen road surface occurs abruptly, or to operate according to the intentions by the driver to be executed, when a change from a frozen road surface to a dry road surface occurs abruptly.

Accordingly, it may be considered to employ a technique in which limitation is applied to the torque setting value Tₛ adaptively on the basis of the results of estimation of the slip ratio and the driving torque at the present time point; these results of estimation can be estimated from the vehicle movement speed v, the wheel rotational speed ω, and the motor current value Iₘ whose current values can be detected quickly. Here, in order to apply limitation to the torque setting value Tₛ in an appropriate manner, a precondition is that it enables to perform estimation of the current values of the slip ratio and the driving torque with good accuracy.

For quick estimation of the current values of slip ratio and driving torque with good accuracy, it is necessary to detect the current values of all of the movement speed v, the rotational speed ω, and the motor current value Iₘ quickly and with good accuracy. However, it is not possible for such quick detection of the current values of all of the movement speed v, the rotational speed ω, and the motor current value Iₘ to be performed with good accuracy during the entire period of vehicle travel.

Due to this, there is a requirement for a technique that can “appropriately” and “rapidly” impose an appropriate limitation upon the torque setting value Tₛ according to the state of the road surface, even if the accuracy of estimation of the current values of the slip ratio and the driving torque cannot be said to be high. One of the problems to be solved is to respond to this requirement.

The present invention has been conceived in consideration of the circumstances described above, and its object is to provide a novel traction control device and a novel traction control method that, according to change of the state of the road surface, are capable of rapidly implementing appropriate control for stable traveling while still ensuring the required drive power.

### Means for Solving the Problems

The invention claimed in claim 1 is a traction control device for a moving body having a driving wheel that is driven by a motor, the traction control device comprising: a movement speed acquisition part acquiring a movement speed of said moving body; a rotational speed acquisition part acquiring a rotational speed of said driving wheel; an actual torque value acquisition part acquiring an actual torque value generated by said motor; a limiting part imposing limitation upon an operation of said motor on the basis of said movement speed, said rotational speed, and said actual torque value; and a feedback part applying feedback to the operation of said motor on the basis of said rotational speed and said actual torque value.

The invention claimed in claim 8 is a traction control method that is used by a traction control device for a moving body having a driving wheel that is driven by a motor, comprising the steps of: acquiring a movement speed of said moving body, a rotational speed of said driving wheel, and an actual torque value generated by said motor; limiting an operation of said motor on the basis of said movement speed, said rotational speed, and said actual torque value; and applying feedback to the operation of said motor on the basis of said rotational speed and said actual torque value.

The invention claimed in claim 9 is a traction control program, wherein it causes a computer in a traction control device for a moving body having a driving wheel that is driven by a motor to execute a traction control method according to claim 8.

And the invention claimed in claim 10 is a recording medium, wherein a traction control program according to claim 9 is recorded thereupon in form that can be read by a computer in a traction control device for a moving body having a driving wheel that is driven by a motor.

### BRIEF DESCRIPTION OF THE DRAWINGS

FIG. 1 is a figure showing variables in a driving wheel model;

FIG. 2 is a figure showing relationships between the slip ratio and the friction coefficient during driving;

FIG. 3 is the first figure showing the results of simulations when traction control is not being performed;

FIG. 4 is the second figure showing the results of simulations when traction control is not being performed;

FIG. 5 is a schematic block diagram showing the configuration of a traction control device according to the first embodiment of the present invention;

FIG. 6 is a figure for explanation of estimated error ratios a and b;

FIG. 7 is a block diagram showing the configuration of a control part in the device shown in FIG. 5;

FIG. 8 is a block diagram showing the configuration of a limiting part in FIG. 7;

FIG. 9 is a figure for explanation of a relationship between slip ratio, driving torque, and a limit value (during driving);

FIG. 10 is the first figure showing the results of simulations of traction processing when no errors are present in the estimated slip ratio and in estimated driving torque;

FIG. 11 is the second figure showing the results of simulations of traction processing when no errors are present in the estimated slip ratio and in the estimated driving torque;

FIG. 12 is a figure showing the results of simulations of traction processing when errors are present in the estimated slip ratio and in the estimated driving torque;

FIG. 13 is a figure for explanation of the relationship between slip ratio, driving torque, and limit value corresponding to the simulation results shown in FIG. 12;

FIG. 14 is a figure for explanation of the relationship between slip ratio, driving torque, and limit value when a limiter coefficient is calculated on the basis of the estimated error ratios a and b;

FIG. 15 is a block diagram showing the configuration of a feedback part in FIG. 7;

FIG. 16 is the first figure showing the results of simulations of traction control by the traction control device of FIG. 5, when no errors are present in the estimated slip ratio and in the estimated driving torque;

FIG. 17 is the second figure showing the results of simulations of traction control by the traction control device shown in FIG. 5, when no errors are present in the estimated slip ratio and in the estimated driving torque;

FIG. 18 is a figure showing the results of simulations of traction control by the traction control device shown in FIG. 5, when errors are present in the estimated slip ratio and in the estimated driving torque;

FIG. 19 is the first figure showing the results of simulations of traction control when the relationship between a limiter coefficient and a feedback gain is as in the case of the first embodiment;

FIG. 20 is the second figure showing the results of simulations of traction control when the relationship between the limiter coefficient and the feedback gain is as in the case of the first embodiment;

FIG. 21 is a figure showing the results of simulations of traction control when the relationship between the limiter coefficient and the feedback gain is different from the case of the first embodiment;

FIG. 22 is a block diagram schematically showing the configuration of a traction control device according to the second embodiment of the present invention;

FIG. 23 is a block diagram showing the configuration of a control part in FIG. 22;

FIG. 24 is a block diagram showing the configuration of a control part of a modified embodiment;

FIG. 25 is a block diagram schematically showing the configuration of a traction control device according to an example of the present invention;

FIG. 26 is a block diagram for explanation of the configurations of a drive control part and a current detection part in a motor drive system in FIG. 25;

FIG. 27 is a flow chart for explanation of processing for traction control performed by the system shown in FIG. 25;

FIG. 28 is a flow chart for explanation of processing for calculation of a limit value corresponding to each of the driving wheels in FIG. 27; and

FIG. 29 is a flow chart for explanation of processing for calculation of a feedback torque value corresponding to each of the driving wheels in FIG. 27.

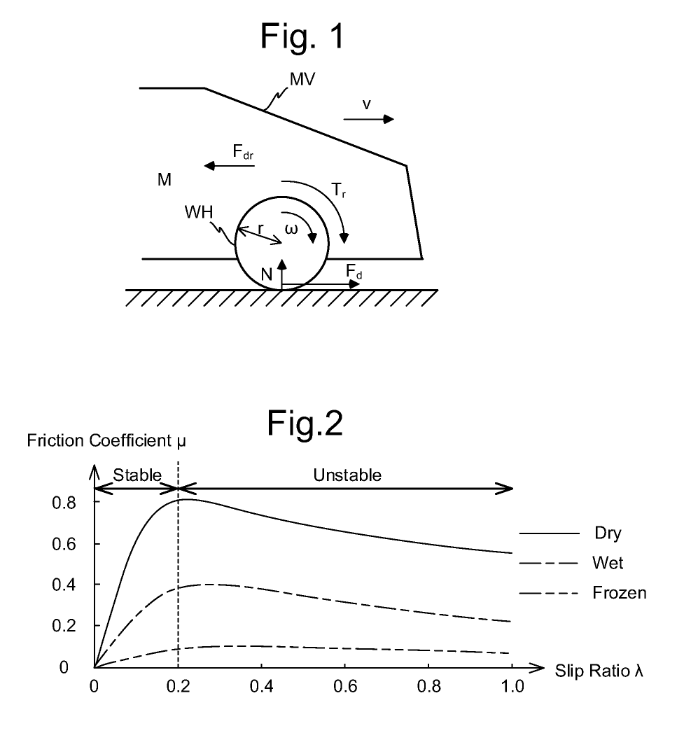

### REFERENCE SIGNS LIST

100 . . . traction control device

110 . . . control unit (movement speed acquisition part, rotational speed acquisition part, actual torque value acquisition part, limiting part, feedback part, torque setting value calculation part, and common torque setting value calculation part)

700A, 700B . . . traction control devices

710 . . . movement speed acquisition part

720 . . . rotational speed acquisition part

730 . . . actual torque value acquisition part

741 . . . limiting part

742 . . . feedback part

743A, 743C . . . torque setting value calculation parts

762 . . . slip ratio estimation part

763 . . . driving torque estimation part

764 . . . limit value calculation part

765 . . . limiter part

782 . . . common torque setting value calculation part

### EMBODIMENT FOR CARRYING OUT THE INVENTION

In the following, embodiments of the present invention will be explained with reference to the appended drawings. Note that, in the following explanation and in the drawings, the same reference symbols are appended to elements that are the same or equivalent, and duplicated explanation is omitted.

### The First Embodiment

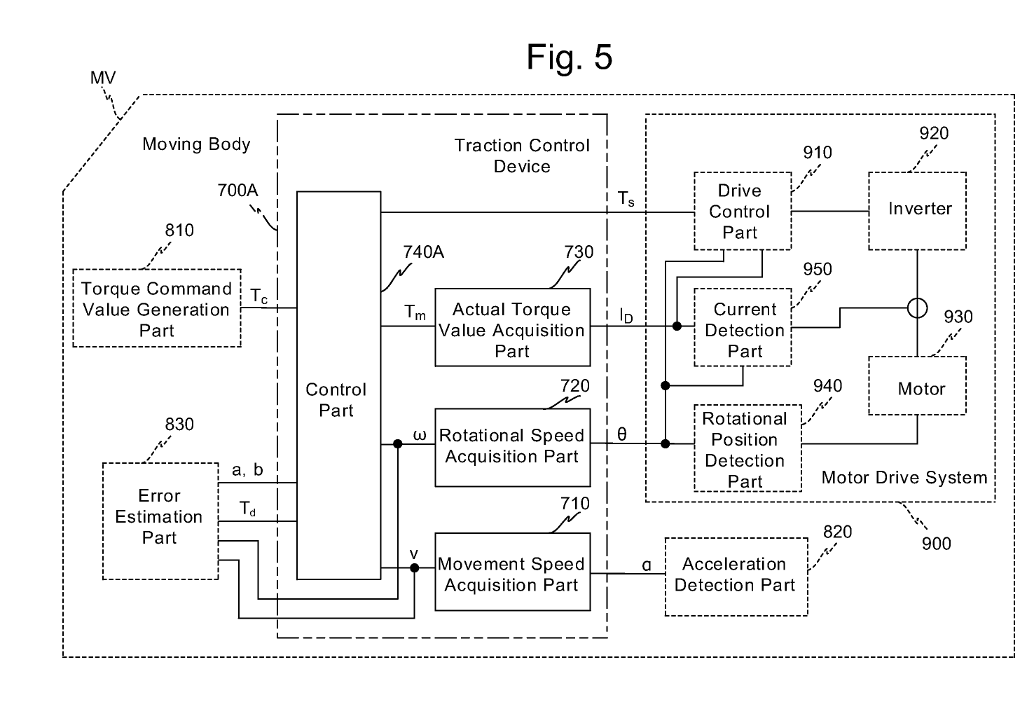

First, the first embodiment of the present invention will be explained with reference to FIGS. 5 through 21.

### <Configuration>

The placement and the configuration of a traction control device 700A according to the first embodiment are shown in FIG. 5 as a block diagram.

### <Placement of the Traction Control Device 700A>

As shown in FIG. 5, the traction control device 700A is arranged within the moving body MV. In addition to the traction control device 700A, a torque command value generation part 810, an acceleration detection part 820, an error estimation part 830, and a motor drive system 900 are provided within this moving body MV, and these parts are connected to the traction control device 700A.

The torque command value generation part 810 generates a torque command value T_{c} on the basis of results being employed in generation of the torque command value T_{c}; these results are detected by an accelerator opening amount sensor, a braking amount sensor, a steering angle sensor and so on not shown in the figures. The torque command value T_{c} that has been generated in this manner is sent to the traction control device 700A.

The acceleration detection part 820 detects the acceleration of the moving body MV in the direction of traveling. The acceleration α that has been detected in this manner is sent to the traction control device 700A.

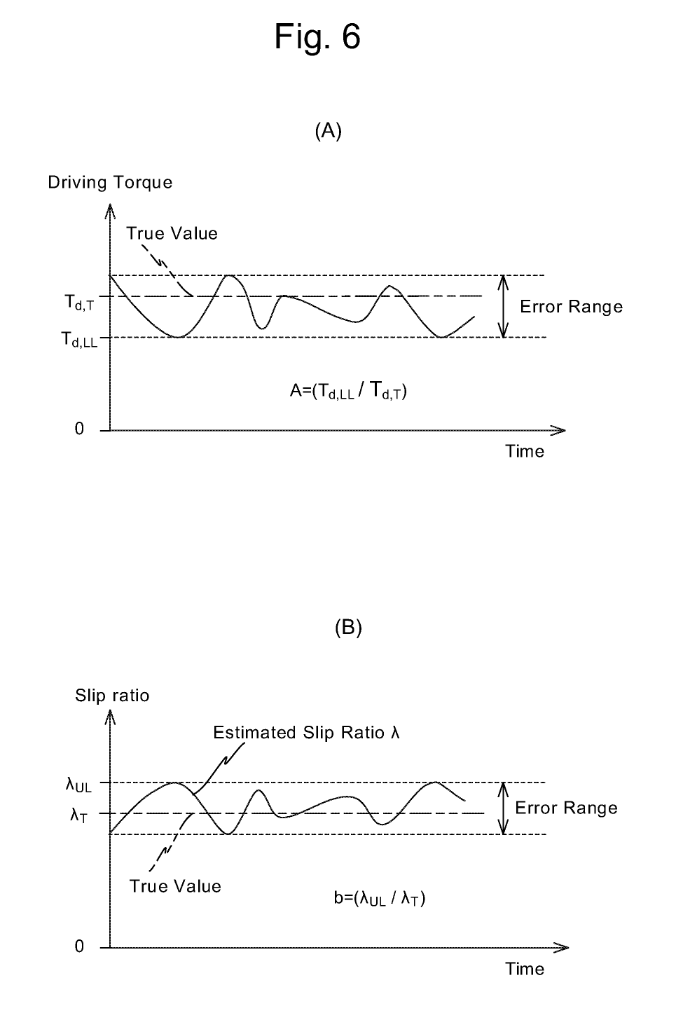

The error estimation part 830 estimates an error range of a slip ratio λ estimated by the traction control device 700A (hereinafter, termed the “estimated slip ratio”) and an error range of a driving torque T_{d} estimated by the traction control device 700A (hereinafter, termed the “estimated driving torque”). And the error estimation part 830 calculates an estimated error ratio a (refer to FIG. 6(A)), which is the ratio of the lower limit value of the error range of the estimated driving torque T_{d} with respect to the true value of the driving torque. Moreover, the error estimation part 830 calculates an estimated error ratio b (refer to FIG. 6(B)), which is the ratio of the upper limit value of the error range of the estimated slip ratio λ with respect to the true value of the slip ratio. The estimated error ratios a and b that have been calculated in this manner are sent to the traction control device 700A.

Note that the calculation of the estimated error ratios a and b by the error estimation part 830 will be described hereinafter.

The motor drive system 900 comprises a drive control part 910, an inverter 920, and a motor 930. Moreover, the motor drive system 900 comprises a rotational position detection part 940 and a current detection part 950.

The drive control part 910 receives a torque setting value Tₛ sent from the traction control device 700A. And the drive control part 910 calculates a drive voltage on the basis of this torque setting value Tₛ, the rotational position θ detected by the rotational position detection part 940, and the detected current value I_{D} detected by the current detection part 950. For example, if the motor 930 is a three-phase motor, then the drive control part 910 calculates a three-phase voltage as the drive voltage. The drive voltage that has been calculated in this manner is sent to the inverter 920.

The inverter 920 receives the drive voltage sent from the drive control part 910. And the inverter 920 supplies current corresponding to the drive voltage to the motor 930. As a result, the motor 930 performs rotational motion on the basis of the torque setting value Tₛ, and rotates the driving wheel.

The rotational position detection part 940 includes a resolver or an encoder. The rotational position detection part 940 detects the rotational position θ of the motor 930. And the rotational position θ that has been detected in this manner is sent to the traction control device 700A, to the drive control part 910, and to the current detection part 950.

And the current detection part 950 detects the value of one or more currents flowing to the motor 930. For example, if the motor 930 is a three-phase motor, then the current detection part 950 detects the values of at least two among the three-phase currents flowing to the motor 930. The current value that has been detected in this manner is sent as a detected current value I_{D} to the traction control device 700A and to the drive control part 910.

<<Calculation of the Estimated Error Ratios a and b>>

Now, the calculation of the estimated error ratios a and b by the error estimation part 830 will be explained.

### (Calculation of the Estimated Error Ratio a)

The traveling resistance F_{dr} is the sum total of the rolling resistance, the air resistance, and the gradient resistance. Thus, if there is no road gradient, the traveling resistance F_{dr} is the sum of the rolling resistance and the air resistance.

The rolling resistance is represented by the following Equation (6):

rolling resistance=μᵣ·M·g (6)

Here μᵣ is the coefficient of rolling resistance, and g is the acceleration of gravity.

Moreover, the air resistance is represented by the following Equation (7):

air resistance=ρ·C_{d}·S·V²/2 (7)

Here, ρ is the air density, C_{d} is the coefficient of air resistance, and S is the projected frontal area.

According to the above, the rolling resistance does not depend upon the movement speed but is a constant, and the air resistance is proportional to the square of the speed. The result is that, if there is no road gradient, the traveling resistance F_{dr} is given by the following Equation (8), where A and B are constants:

F_{dr}=A+B·v² (8)

Thus, when the vehicle is coasting onward under its own inertia without the driver stepping upon either the accelerator pedal or the brake pedal, during the inertial coasting travel, it enables to estimate the constants A and B by the least-square method on the basis of relationship between the change of the traveling resistance F_{dr} and the change of the movement speed v; the relation is given by Equation (2). Note that the wheel speed of the driving wheel (=r·ω) is employed as the movement speed when estimating the constants A and B, because no slippage is generated during inertial coasting travel caused by the driving wheels being neither driven nor braked.

After the constants A and B have been estimated in this manner, pseudo engine braking with a weak braking torque is performed for either the front wheels or the rear wheels of a four wheel drive vehicle, for example. And the rotational speed of a driving wheel to which no braking torque is applied (=r·ω) is taken as being the speed v of the vehicle, and the traveling resistance F_{dr} is calculated by using Equation (8). Subsequently, the true value of the driving torque (=r·F_{d}) is calculated after having calculated the driving force F_{d} by using the relationship of Equation (2).

The error estimation part 830 calculates the true value of the driving torque according to the method described above. Subsequently, the error estimation part 830 compares the true value of the driving torque with the estimated driving torque T_{d} estimated by the traction control device 700A that uses the relationship of Equation (3), and obtains an error range for the estimated driving torque T_{d}; and, the error estimation part 830 estimates the range of the error range of the estimated driving torque T_{d}, then calculates the estimated error ratio a.

### (Calculation of the Estimated Error Ratio b)

When the driver does not step upon either the accelerator pedal or the brake pedal while the electric automobile is traveling, it is usual either to perform inertial traveling or to perform control by applying pseudo engine braking with a weak braking torque. Thus, supposing that this automobile has four driving wheels, by performing setting while pseudo engine braking is being applied so that no braking torque is applied to either the front wheels or the rear wheels, it enables to calculate the true value of the movement speed (=r·ω) of the vehicle from the wheel speed of this driving wheel to which no braking torque is applied.

The error estimation part 830 calculates the true value of the movement speed by the method described above. Subsequently, the error estimation part 830 compares the true value of the movement speed with the movement speed v that has been acquired by time integration of the acceleration a in the traction control device 700A, and specifies the error range of the movement speed v; and then the error estimation part 830 calculates the estimated error ratio b, after having estimated the range of the estimated error of the estimated slip ratio λ on the basis of the error range of the movement speed.

The estimated error ratios a and b can be calculated by the method described above, when neither the accelerator pedal nor the brake pedal is being stepped upon while the vehicle is traveling upon a level road. Although, having obtained these estimated error ratios a and b once, there is no need to calculate them again repeatedly, nevertheless, the higher the frequency of calculation can be, the better is it possible to respond to changes of these error ratios over time.

### <Configuration of the Traction Control Device 700A>

As shown in FIG. 5, the traction control device 700A comprises a movement speed acquisition part 710, a rotational speed acquisition part 720, an actual torque value acquisition part 730, and a control part 740A.

The movement speed acquisition part 710 receives the acceleration α sent from the acceleration detection part 820. And the movement speed acquisition part 710 performs time integration of the acceleration α, and thereby acquires the speed of movement v. The movement speed that has been acquired in this manner is sent to the control part 740A and to the error estimation part 830.

The rotational speed acquisition part 720 receives the rotational position θ sent from the rotational position detection part 940. And the rotational speed acquisition part 720 performs time differentiation of the rotational position θ, and thereby acquires the rotational speed ωo. The rotational speed ω that has been acquired in this manner is sent to the control part 740A and to the error estimation part 830.

The actual torque value acquisition part 730 receives the detected current value I_{D} sent from the current detection part 950. And next the actual torque value acquisition part 730 calculates the motor current value Iₘ on the basis of this detected current value I_{D}. Note that the motor current value Iₘ represents the absolute magnitude of the detected current value I_{D}, in other words Iₘ=|I_{D}|.

Next, the actual torque value acquisition part 730 acquires the actual torque value Tₘ by calculating the actual torque value Tₘ by using Equation (1). The actual torque value Tₘ that has been acquired in this manner is sent to the control part 740A.

The control part 740A receives the torque command value T_{c} sent from the torque command value generation part 810 and the estimated error ratios a and b sent from the error estimation part 830. Subsequently, the control part 740A performs torque control upon the torque command value T_{c} on the basis of the speed of movement v, the rotational speed ω, and the actual torque value Tₘ, and thereby calculates the torque setting value Tₛ. And the control part 740A sends this torque setting value Tₛ that has thus been calculated to the drive control part 910.

Note that, if no command is issued to the effect that traction control should be performed, then the torque control part 740A is adapted to send the torque command value T_{c} to the drive control part 910 as the torque setting value Tₛ.

Moreover, the control part 740A sends the estimated driving torque T_{d} to the error estimation part 830. Note that the control part 740A performs the calculation of the estimated driving torque T_{d} and sends the estimated driving torque T_{d} that has thus been calculated to the error estimation part 830, irrespective of whether or not any command has been issued to the effect that traction control should be performed.

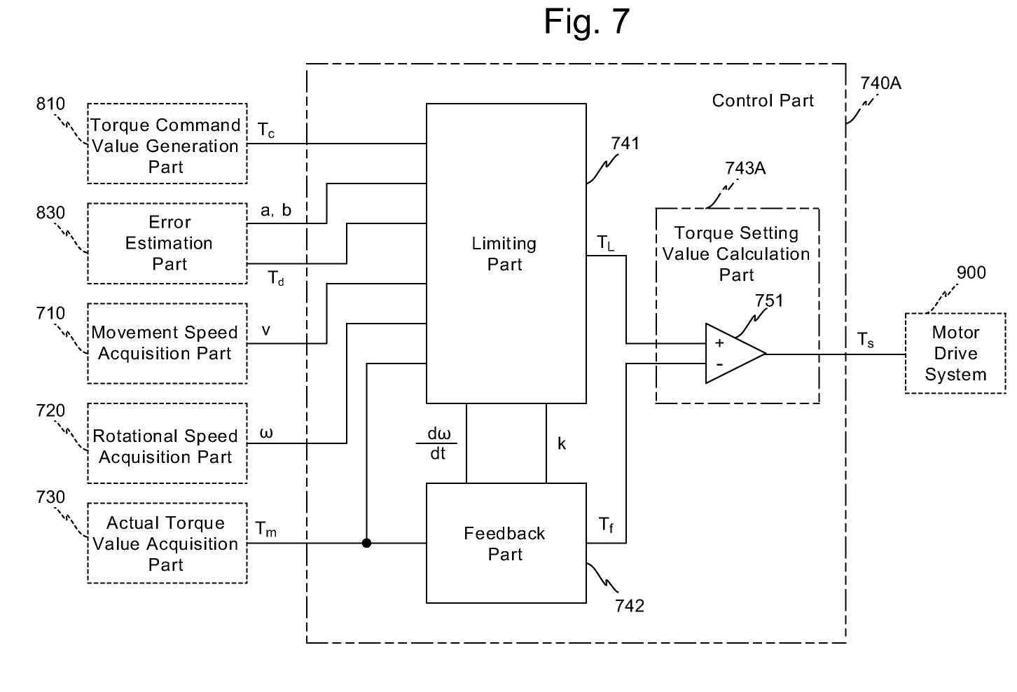

As shown in FIG. 7, the control part 740A having the function described above comprises a limiting part 741 and a feedback part 742. Moreover, the control part 740A comprises a torque setting value calculation part 743A.

The limiting part 741 receives the torque command value T_{c} sent from the torque command value generation part 810 and the estimated error ratios a and b sent from the error estimation part 830. And the control part 740A performs limitation control upon the torque command value T_{c} on the basis of the speed of movement v, the rotational speed ω, and the actual torque value Tₘ, and thereby calculates a limited torque value T_{L}. And the limiting part 741 sends this limited torque value T_{L} that has thus been calculated to the torque setting value calculation part 743A.

Note that, if no command is issued to the effect that traction control should be performed, then the limiting part 741 sends the torque command value T_{c} to the torque setting value calculation part 743A as the limited torque value T_{L}.

Moreover, the limiting part 741 sends a limiter coefficient k that has been calculated at an intermediate stage of the calculation of the limited torque value T_{L} and the differential value (dω/dt) the of the rotational speed ω with respect to time to the feedback part 742. Furthermore, the limiting part 741 sends the estimated driving torque T_{d} that has been calculated at an intermediate stage of the calculation of the limited torque value T_{L} to the error estimation part 830.

Note that the limiting part 741 performs the calculation of the estimated driving torque T_{d} and sends the estimated driving torque T_{d} that has thus been calculated to the error estimation part 830, irrespective of whether or not any command has been issued to the effect that traction control should be performed.

The details of the configuration of the limiting part 741 having the above described functions will be described hereinafter.

The feedback part 742 receives the limiter coefficient k and the time differentiated value (dω/dt) of the rotational speed ω sent from the limiting part 741, and the actual torque value Tₘ sent from the actual torque value acquisition part 730. And, on the basis of the limiter coefficient k, the time differentiated value (dω/dt), and the actual torque value Tₘ, the feedback part 742 calculates a feedback torque value T_{f}. And the feedback part 742 sends the feedback torque value T_{f} that has thus been calculated to the torque setting value calculation part 743A. Note that, if no command to the effect that traction control is to be performed has been issued, then the feedback part 742 sends “0 [Nm]” to the torque setting value calculation part 743A as the feedback torque value T_{f}.

Note that the details of the configuration of the feedback part 742 will be described hereinafter.

The torque setting value calculation part 743A has a configuration that includes a subtraction part 751. The torque setting value calculation part 743A receives the limited torque value T_{L} sent from the limiting part 741 and the feedback torque value T_{f} sent from the feedback part 742. And, the torque setting value calculation part 743A calculates a torque setting value Tₛ according to the following Equation (9), and sends the calculated torque setting value Tₛ to the motor drive system 900.

Tₛ=T_{L}−T_{f} (9)

### <<Configuration of the Limiting Part 741>>

Next, the configuration of the limiting part 741 will be explained.

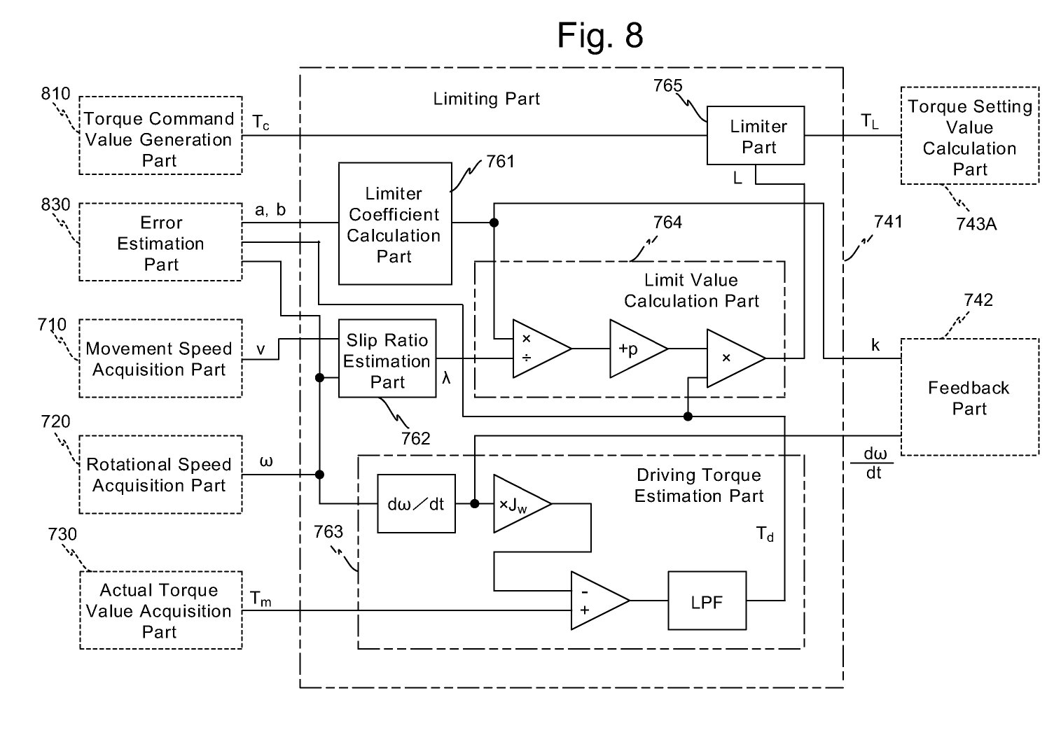

As shown in FIG. 8, the limiting part 741 comprises a limiter coefficient calculation part 761, a slip ratio estimation part 762, and a driving torque estimation part 763. Moreover, the limiting part 741 comprises a limit value calculation part 764 and a limiter part 765.

The limiter coefficient calculation part 761 receives the estimated error ratios a and b sent from the error estimation part 830. And the limiter coefficient calculation part 761 calculates a limiter coefficient k on the basis of the estimated error ratios a and b. The limiter coefficient k that has been calculated in this manner is sent to the limit value calculation part 764 and to the feedback part 742.

Note that the processing performed by the limiter coefficient calculation part 761 for calculating the limiter coefficient k will be described hereinafter.

The slip ratio estimation part 762 receives the movement speed v sent from the movement speed acquisition part 710 and the rotational speed ω sent from the rotational speed acquisition part 720. And the slip ratio estimation part 762 performs slip ratio estimation by calculating the estimated slip ratio λ according to Equation (5) described above. The estimated slip ratio λ that has been calculated in this manner is sent to the limit value calculation part 764.

The driving torque estimation part 763 receives the rotational speed ω sent from the rotational speed acquisition part 720 and the actual torque value Tₘ sent from the actual torque value acquisition part 730. Subsequently, the driving torque estimation part 763 performs driving torque estimation by calculating the estimated driving torque T_{d} by passing the value obtained according to the following Equation (10), which is a variant of Equation (3) described above, through a low pass filter (LPF):

T_{d}=Tₘ−J_{w}·(dω/dt) (10)

The estimated driving torque T_{d} that has been calculated in this manner is sent to the limit value calculation part 764 and to the error estimation part 830.

Furthermore, the driving torque estimation part 763 sends the time differentiated value (dω/dt) of the rotational speed ω calculated at an intermediate stage in the calculation of the estimated driving torque T_{d} according to Equation (10) to the feedback part 742.

The limit value calculation part 764 receives the estimated slip ratio λ sent from the slip ratio estimation part 762 and the estimated driving torque T_{d} sent from the driving torque estimation part 763. Moreover, the limit value calculation part 764 receives the limiter coefficient k sent from the limiter coefficient calculation part 761. And the limit value calculation part 764 calculates the limit value L on the basis of the limiter coefficient k, the estimated slip ratio λ, and the estimated driving torque T_{d}. The limit value L that has been calculated in this manner is sent to the limiter part 765.

Note that, in the first embodiment, the limit value L is calculated according to the following Equation (11):

L=T_{d}·(p+k/λ) (11)

Here, the constant p is determined in advance according to experiment, simulation or the like from the standpoint of performing appropriate traction control.

The limiter part 765 receives the torque command value T_{c} sent from the torque command value generation part 810. And the limiter part 765 performs limitation control upon the torque command value T_{c} according to the limit value L sent from the limit value calculation part 764, and calculates a limited torque value T_{L}.

During this limitation control, if no command to the effect that traction control is to be performed has been issued, and if also the torque command value T_{c} is less than or equal to the limit value L, then the limiter part 765 takes the torque command value T_{c} as the limited torque value T_{L}. Moreover, if a command to the effect that traction control is to be performed has been issued, and moreover the torque command value T_{c} is greater than the limit value L, then the limiter part 765 takes the limit value L as the limited torque value T_{L}. The limited torque value T_{L} that has been calculated in this manner is sent to the torque setting value calculation part 743A.

### (Processing for Calculation of the Limiter Coefficient)

Now, the processing performed by the limiter coefficient calculation part 761 described above for calculation of the limiter coefficient k will be explained.

### ((Relationship Between the Phenomenon of Slipping of the Moving Body and the Driving Torque))

First, the relationship between the phenomenon of slipping of the moving body and the driving torque will be explained.

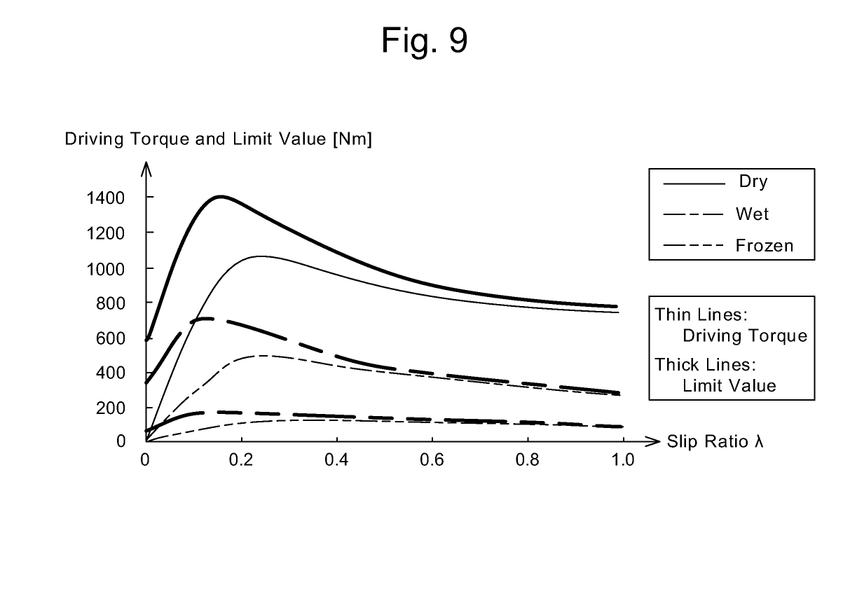

The relationship “T_{d}=r·F_{d}=R·μ·N” is established by Equations (3) and (4) described above. Due to this, if there are no changes in the radius r of the driving wheel and in the normal reaction force N, then, as shown by the thin lines in FIG. 9, the slip ratio and the driving torque are in the same relationship as the slip ratio and the friction coefficient in FIG. 2. As will be understood from Equation (3), the rotational speed ω increases when the actual torque value Tₘ is larger as compared to the value of the current driving torque T_{d} during traveling, and the slip ratio given Equation (5) also increases.

In this type of case, different operations take place, depending upon the value of the slip ratio. If the slip ratio is less than or equal to “0.2”, then, as shown in FIG. 9, the driving force F_{d} increases, since the driving torque also increases. By this, if the change of F_{dr} due to air resistance and so on is small, then the speed of movement v also increases, as shown by Equation (2). Accordingly it enables to travel in a stable manner, since the increase of the slip ratio given by Equation (5) is mitigated. On the other hand, if the slip ratio is greater than “0.2”, then, as shown in FIG. 9, then the driving torque does not increase. Thereby, the driving force F_{d} also does not increase, and the movement speed v given by Equation (2) also does not increase. As a result, the increase of the slip ratio shown by Equation (5) progresses, which is not desirable, and accordingly traveling becomes unstable, since the slip ratio becomes yet greater.

Which of these operations actually takes place is determined by the relationship between the maximal value of the driving torque and the actual torque value Tₘ. If the actual torque value Tₘ is sufficiently smaller than the maximal value of the driving torque with room to spare, then it is possible to maintain stable travel. On the other hand, if the actual torque value Tₘ has become greater than the maximal value of the driving torque, then the system enters the unstable region, which is undesirable.

An example of the calculation of the limit value L by using Equation (11) is shown in FIG. 9. If the limited torque value T_{L} with which limitation processing is performed upon the torque command value T_{c} according to the limit value L is taken as being the torque setting value Tₛ, then, the larger the slip ratio λ is, the closer the limit value L is set to the driving torque, and, conversely, the smaller the slip ratio λ is, the limit value L can be set to the more removed from the driving torque.

Accordingly, the torque setting value Tₛ is limited to a value that is closer to the current driving torque T_{d}, the greater the slip ratio λ is. Moreover, since the torque limitation becomes weaker the smaller the slip ratio λ is, accordingly a larger margin for the torque setting value Tₛ to exceed the current driving torque T_{d} is permitted.

Note that, since the limit value L is closer to the estimated driving torque Td the larger the estimated slip ratio λ is, accordingly it is desirable for the constant p to be set to a value that is close to “1”. Accordingly, in the first embodiment, “1” is employed as the constant p, so that the limit value L is calculated according to the following Equation (12):

L=T_{d}·(1+k/2) (12)

Moreover since, the smaller the limiter coefficient k is set, the stronger a limitation can be imposed, accordingly a stronger torque limitation is imposed when the estimated slip ratio λ becomes large, and as a result it enables to suppress increase of the slip ratio. However, it is not desirable to set the limiter coefficient k to be too small, because it is not desirable to impose more torque limitation than necessary, if the estimated slip ratio λ is within the stable region.

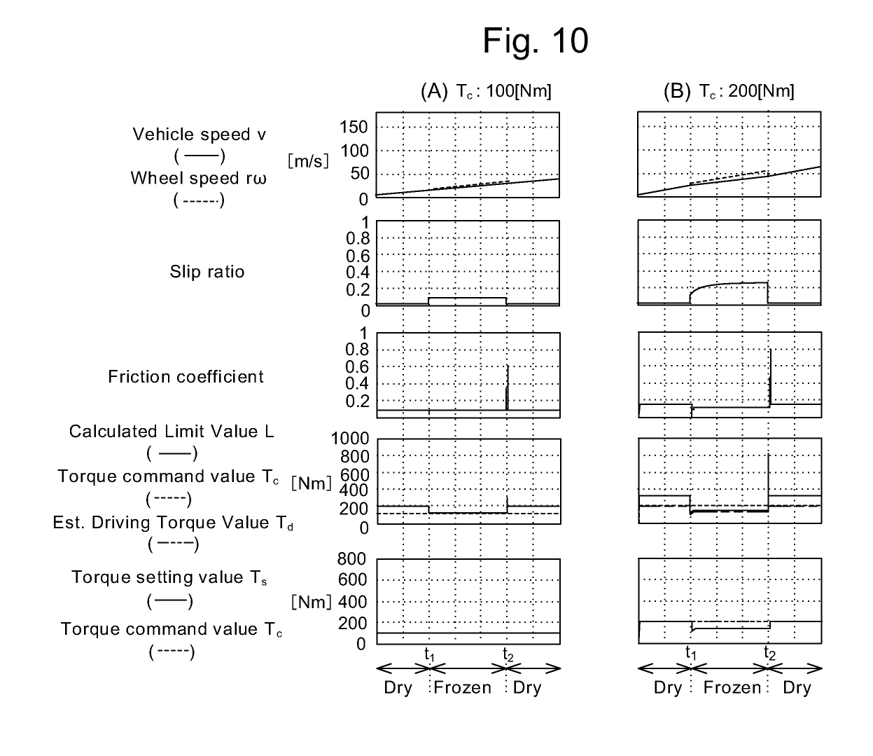

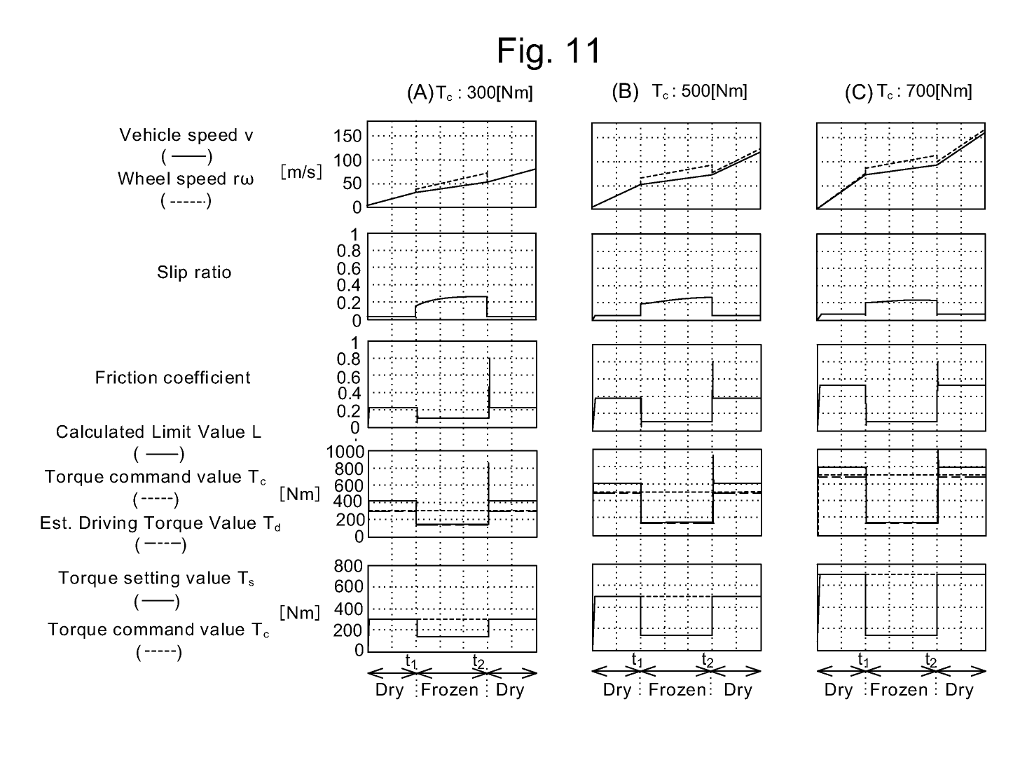

The results of simulations of anti-slip performance during driving are shown in FIGS. 10 and 11, in cases when the limited torque value T_{L} is taken as the torque setting value Tₛ when the limiter coefficient k in Equation (12) is set to “0.01”. Note that as conditions for these simulations, in a similar manner to the case of the simulations when the limitation control described above was not performed, the conditions were employed that: the electric automobile was a four wheel drive vehicle; its weight was 1800 [kg]; the moment of inertia of the driving wheel WH was 1.2 [kg·m²]; and the torque response of the motor was 5 [ms]. Moreover, the simulations were performed under the assumption that the road surface changed from dry to frozen at the time point t₁, and changed back from frozen to dry at the time point t₂ (>t₁).

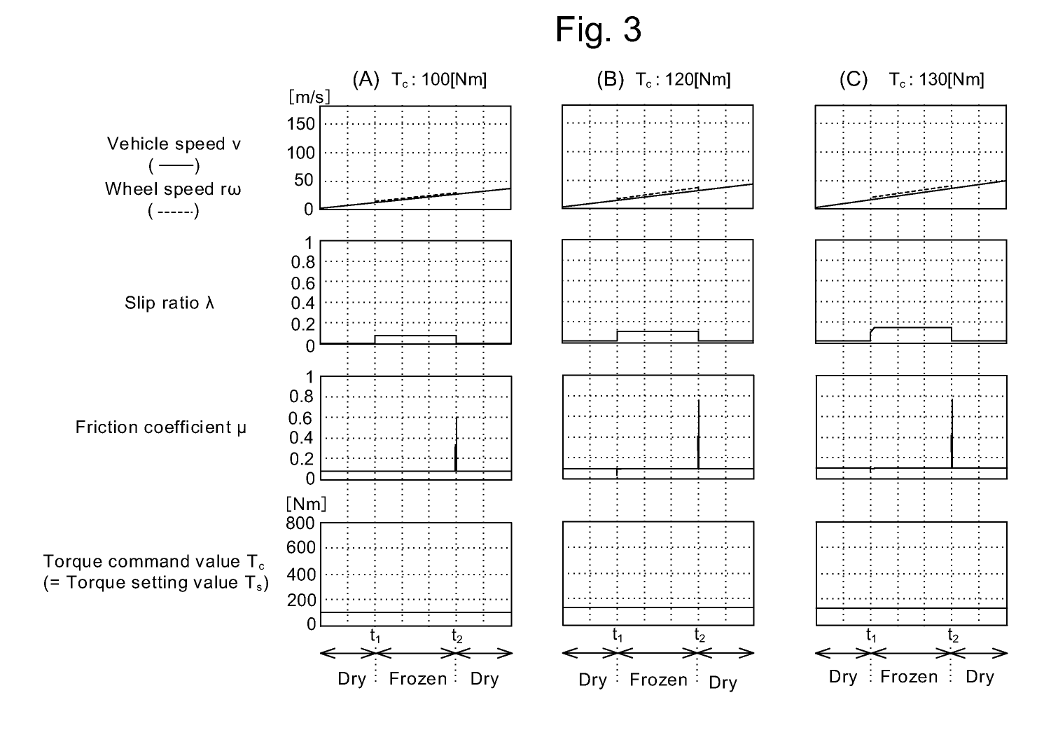

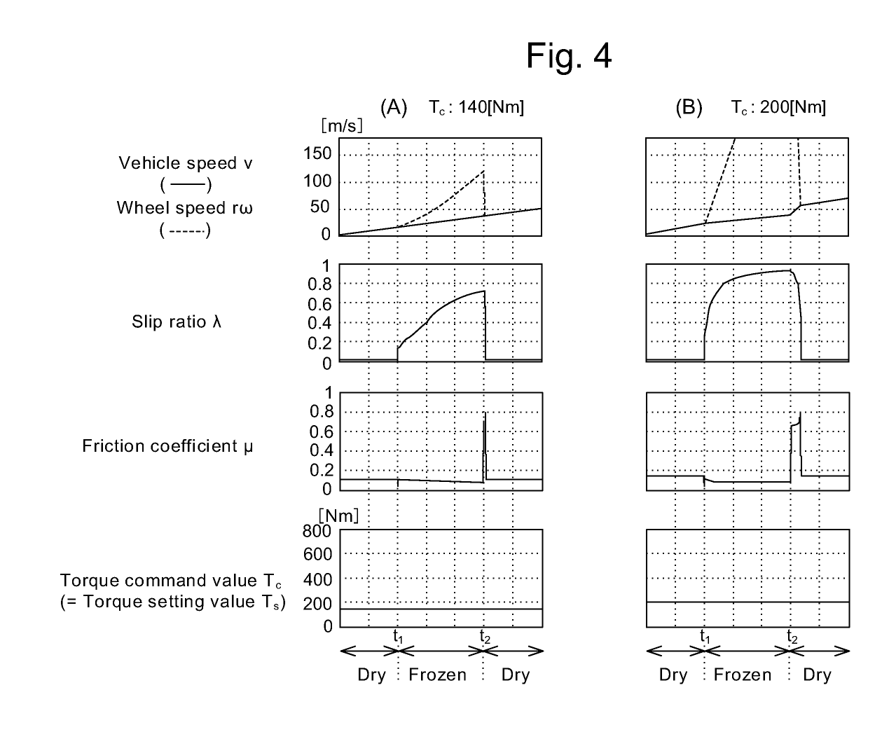

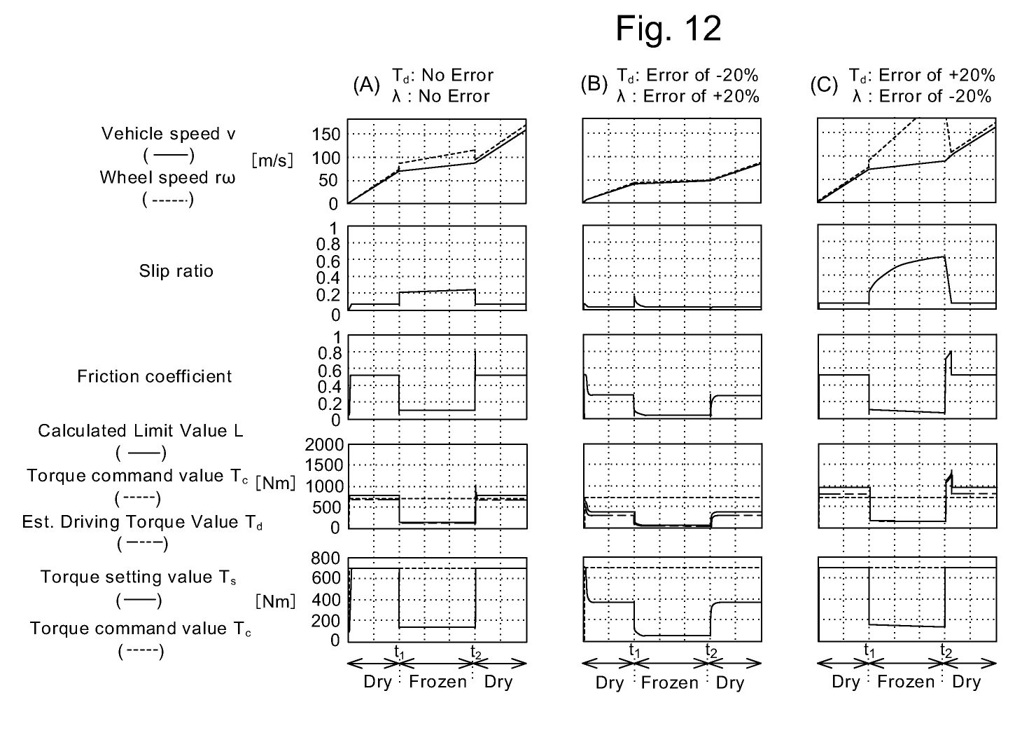

Note that in FIGS. 10 and 11 (and the same holds for FIGS. 12 and 16 through 21 that will be described hereinafter), as the results of simulations of when limitation control is not performed, in addition to the vehicle speed v, the wheel speed (r·ω), the slip ratio, and the friction coefficient shown in FIGS. 3 and 4, the results of simulations are also shown for the limit value L, the estimated driving torque T_{d}, the torque setting value Tₛ, and the limited torque value T_{L} that are calculated. Thus, these are figures in which comparisons for the limit value L (called the “calculated limit value L” in FIGS. 10 through 12 and FIGS. 16 through 21), the torque setting value Tₛ, and the limited torque value T_{L} that are calculated with the torque command value T_{c} become simple and easy.

As shown overall in FIGS. 10 and 11, since the limit value L on a dry road surface is greater than the torque command value T_{c}, accordingly the torque setting value Tₛ is not limited. When the vehicle enters upon a frozen road surface, the torque setting value Tₛ instantaneously becomes limited by the limit value L, because the limit value L decreases to below the torque setting value Tₛ. As a result, it enables to confirm that increase of the slip ratio λ can be suppressed. In other words, it may be confirmed that it is possible for sufficient acceleration upon a dry road surface, and also travel upon a frozen road surface with slippage being prevented, to be compatible.

### (Influence of the Estimated Errors in the Slip Ratio and the Driving Torque)

Next, the influence of the estimated errors in the slip ratio λ and the driving torque T_{d} upon the anti-slip performance will be explained.

The results of simulations are shown in FIG. 12, when errors are included in the estimated slip ratio λ and in the estimated driving torque T_{d}, along with comparison examples for the case when the errors are not present. Note that the conditions for these simulations were the same as in the case of FIG. 11(C) described above.

As shown in FIG. 12, when errors are included in the estimated slip ratio λ and in the estimated driving torque T_{d}, the torque setting value Tₛ may be reduced even if limitation control is performed upon a dry road surface, and/or suppression of increase of the slip ratio upon a frozen road surface may not be sufficient. Accordingly, it was understood that the performance for traction control was undesirably deteriorated when the estimated errors in the estimated slip ratio λ and in the estimated driving torque T_{d} were large.

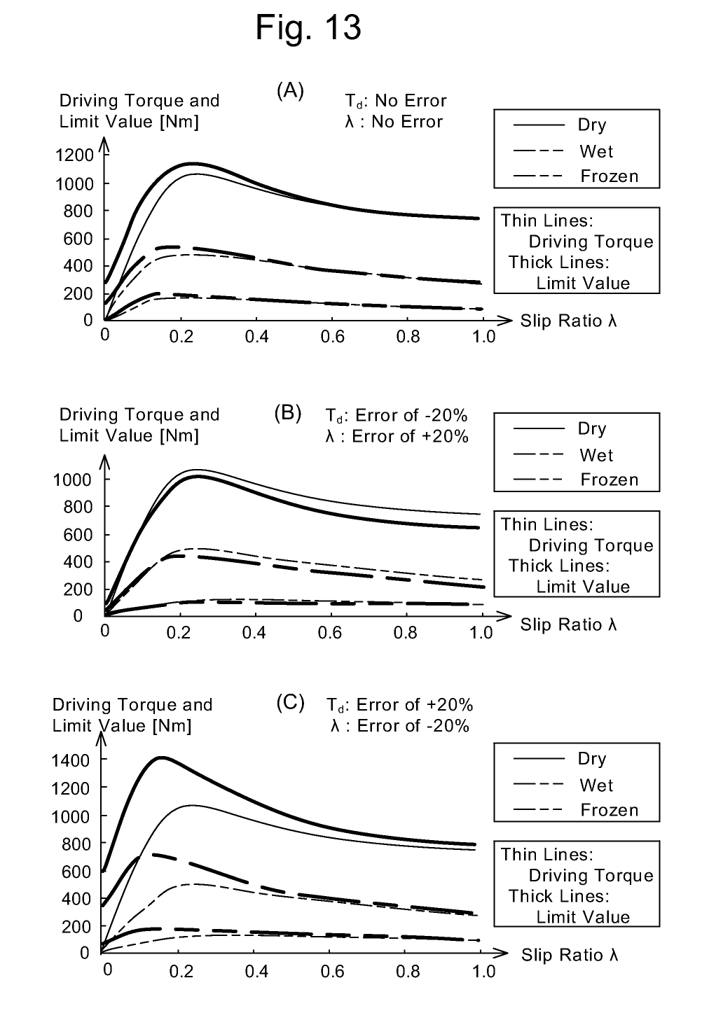

By contrast, the results of calculation of the limit value L when errors are included in the estimated slip ratio λ and in the estimated driving torque T_{d} using the calculation of the limit value L are shown in FIG. 13, along with comparison examples when no errors are present. If, using the calculation of the limit value L, errors are included in the estimated slip ratio λ and/or in the estimated driving torque T_{d}, then, as shown in FIG. 13(B), in some cases the necessary driving torque is not obtained, since limitation is performed with a limit value that is smaller than the driving torque. Moreover, as shown in FIG. 13(C), on a slippery road surface the reduction of torque becomes insufficient, which is undesirable, because limitation of the driving torque is performed with a limit value that is too loose. The occurrence of this phenomenon also can be seen in the simulation results shown in FIG. 12 and described above.

### (Calculation of the Limiter Coefficient)

In the first embodiment, in consideration of the influence of the estimated errors in the estimated slip ratio λ and in the estimated driving torque T_{d}, the limiter coefficient calculation part 761 calculates the limiter coefficient k according to the estimated errors in the estimated slip ratio λ and the estimated driving torque T_{d}.

During this calculation of the limiter coefficient k, the limiter coefficient calculation part 761 acquires the estimated error ratios a and b sent from the error estimation part 830. If these estimated error ratios a and b are present, then the limit value L is calculated according to the following Equation (13):

L=a T_{d}·(1+k/(b·λ)) (13)

In Equation (13), the limit value L including errors is calculated by taking the estimated slip ratio λ as b times the true value of the slip ratio, and the estimated driving torque T_{d} as a times the true value of the driving torque.

If the limiter coefficient when there are no errors in the estimated slip ratio λ and in the estimated driving torque T_{d} is written as “k*”, then the condition that Equation (13) should be the same as Equation (12) described above becomes as shown in the following Equation (14):

a·T_{d}·(1+k/(b·λ))=T_{d}·(1+k*/λ) (14)

The result when the limiter coefficient k is obtained from Equation (14) is given by the following Equation (15):

k=k*·(b/a)+λ·((b/a)−b) (15)

Here, if there are no estimated errors in the estimated slip ratio λ and the estimated driving torque T_{d}, “0.01” is an adequate value for the limiter coefficient k*, as shown by the simulation results in FIGS. 10 and 11 described above. Moreover, with regard to the slip ratio, as shown in FIG. 2 described above, “0.2” is the boundary between the stable region and the unstable region (in other words, the slip ratio at which the friction coefficient becomes maximal). Accordingly, in the first embodiment, the limiter coefficient calculation part 761 is adapted to calculate the limiter coefficient which it supplies to the limit value calculation part 764 according to the following Equation (16):

k=0.01·(b/a)+0.2·((b/a)−b) (16)

Note that Equation (16) is obtained by substituting k*=0.01 and λ=0.2 into Equation (15).

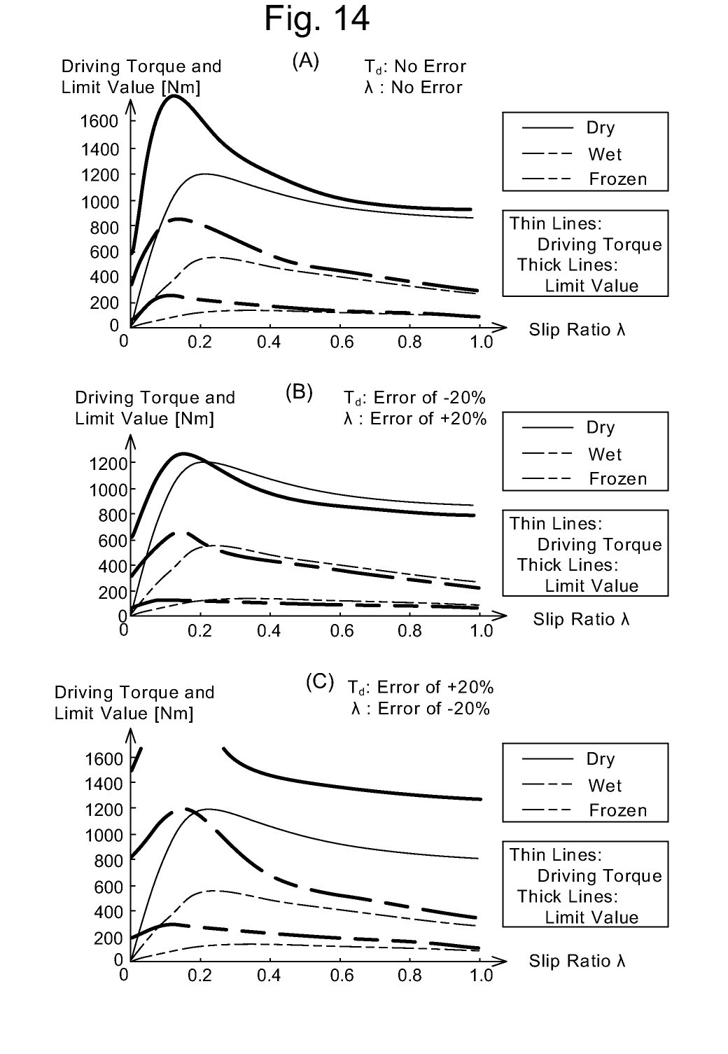

Examples with limit values L calculated according to Equation (12) are shown in FIG. 14, when the limiter coefficient k calculated according to the Equation (16) is employed. As shown in FIG. 14(B), the difference from the case of FIG. 13(B) is that, when the slip ratio is less than or equal to “0.2”, the limit value L does not become too small, so that stronger limitation than required is not imposed. In other words, even if some estimated errors are included in the estimated slip ratio λ and/or in the estimated driving torque T_{d}, it enables to avoid stronger limitation than required being imposed in the stable region.

Note that, in the case of FIG. 14(C) in which the direction of the error is opposite from the case shown in FIG. 14(B), undesirably weak limitation is imposed. However, it is arranged to overcome this problem by using, together in parallel, both the adaptive limitation processing performed by the limiting part 741 and feedback processing performed by the feedback part 742 as will be described hereinafter.

### <<Configuration of the Feedback Part 742>>

Next, the configuration of the feedback part 742 will be explained.

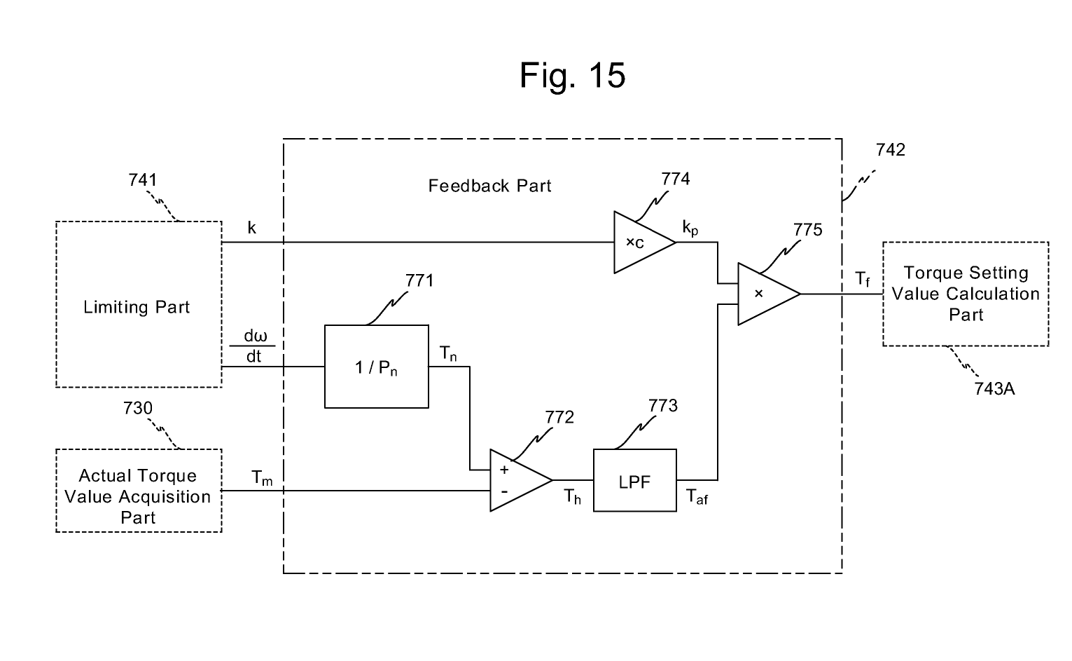

As shown in FIG. 15, the feedback part 742 comprises an adhesive model part 771, a subtraction part 772, and a low pass filter part (LPF) 773. Moreover, the feedback part 742 comprises a feedback gain calculation part 774 and a multiplication part 775.

The adhesive model part 771 can be described as a transfer function given by “Pₙ⁻¹=J_{W}+M·r²”. The adhesive model part 771 receives the time differentiated value (dω/dt) of the rotational speed w sent from the limiting part 741. And, according to the following Equation (17), the adhesive model part 771 calculates a torque value Tₙ corresponding to the time differentiated value (dω/dt) according to an adhesive model, which is a virtual model in which slipping of the driving wheel does not occur, and sends the torque value Tᵣ, that has thus been calculated to the subtraction part 772.

Tₙ=Pₙ⁻¹·(dω/dt) (17)

Note that in the following the torque value Tₙ, is also sometimes termed the “back-calculated torque value Tₙ”, because the torque value Tₙ is back-calculated from the rotational speed w by employing the adhesive model.

The subtraction part 772 receives the back-calculated torque value Tₙ sent from the adhesive model part 771 and the actual torque value Tₘ sent from the actual torque acquisition part 730. And the subtraction part 772 calculates a differential torque value Tₕ according to the following Equation (18), and sends the differential torque value Tₕ that has thus been calculated to the LPF part 773.

Tₕ=Tₙ−Tₘ (18)

The LPF part 773 receives this differential torque value Tₕ sent from the subtraction part 772. And the LPF part 773 performs filtering processing upon the differential torque value Tₕ, calculates the after-filtering torque value T_{af}, and sends the after-filtering torque value T_{af} that has thus been calculated to the multiplication part 775.

The feedback gain calculation part 774 receives the limiter coefficient k sent from the limiting part 741. And, using a constant c that is predetermined, the feedback gain calculation part 774 calculates a feedback gain kₚ according to the following Equation (19), and sends the feedback gain kₚ that has thus been calculated to the multiplication part 775.

kₚ=c·k (19)

Note that the constant c will be described hereinafter.

The multiplication part 775 receives the after-filtering torque value T_{af} sent from the LPF part 773 and the feedback gain kₚ sent from the feedback gain calculation part 774. And the multiplication part 775 calculates the feedback torque value T_{f} according to the following Equation (20), and sends the feedback torque value T_{f} that has thus been calculated to the torque setting value calculation part 743A.

T_{f}=kₚ·T_{af} (20)

### (About the Constant c)

Now, the constant c that is utilized during the calculation of the feedback gain kₚ by the feedback gain calculation part 774 will be explained.

In the first embodiment, as described above, the feedback gain kₚ corresponding to the value of the limiter coefficient k calculated by the limiting part 741 is calculated by Equation (19) above. Due to this, if the limiter coefficient k is small and the limitation is strong, then the feedback gain kₚ is small and the feedback control becomes weak. On the other hand, if the limiter coefficient k is large and the limitation is weak, then the feedback gain kₚ is large and the feedback control becomes strong.

As the result of investigation as to how to obtain an appropriate torque setting value via these two types of torque reduction, via i.e. torque reduction by adaptive limitation control by the limiting part 741 and via torque reduction by model tracking control utilizing the feedback part 742, it has been discovered that it is optimum to take the constant c as being “10”, thus calculating the feedback gain kₚ according to the following Equation (21):

kₚ=10·k (21)

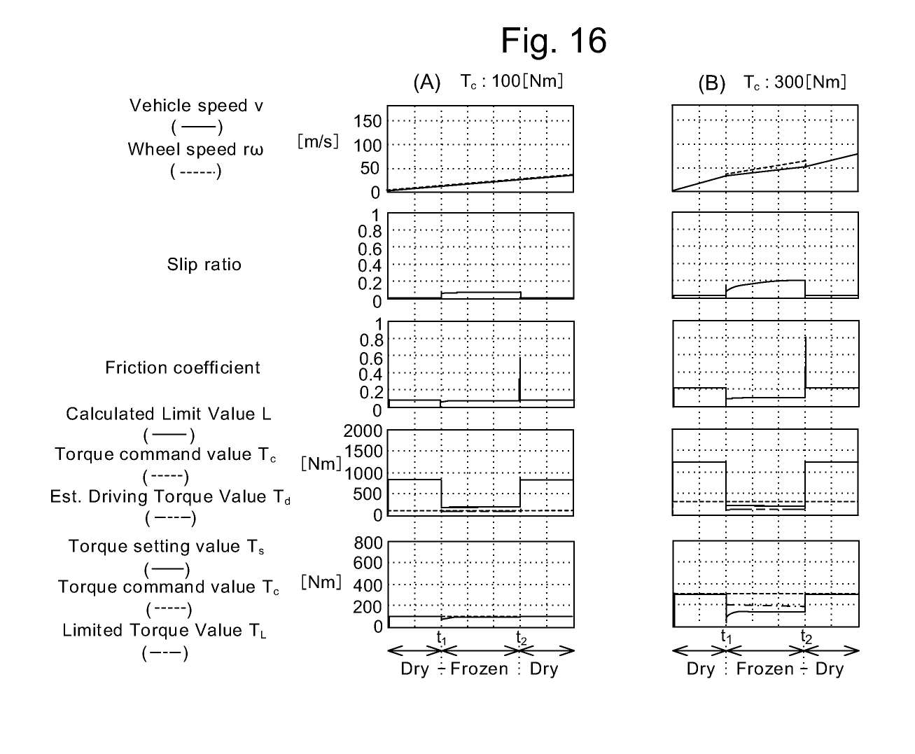

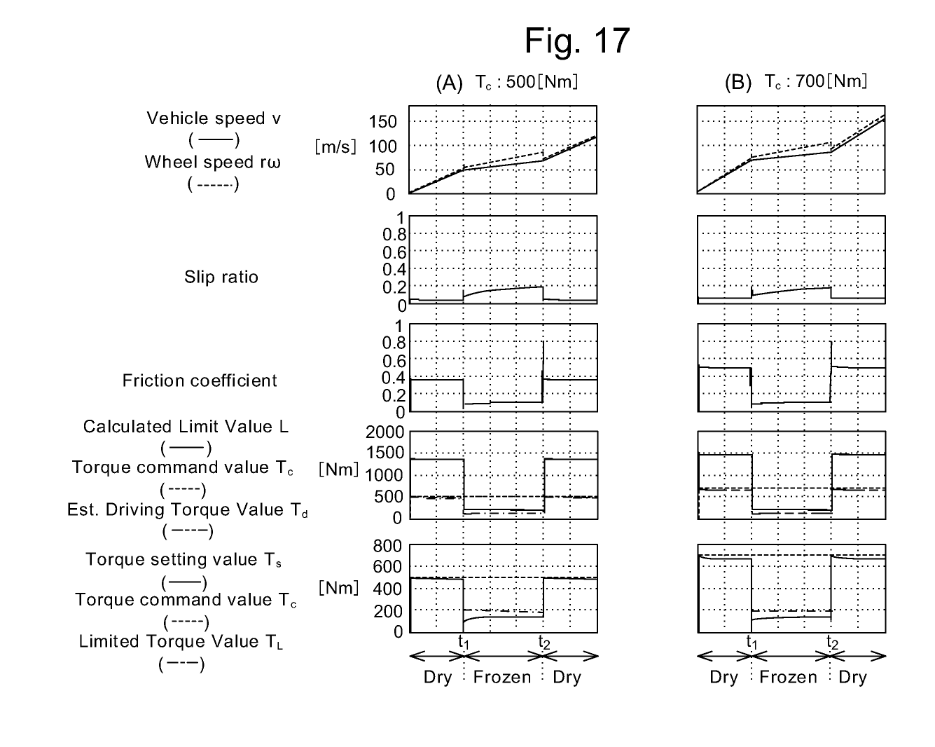

In FIGS. 16 and 17, the results of similar simulations of the anti-slip performance when the feedback gain kₚ is calculated by using Equation (21) are shown. Note that the conditions for these simulations were the same as those in FIGS. 10 and 11, with k=0.075 and kₚ=0.75.

As shown in FIGS. 16 and 17, in places where the road surface is frozen, limitation is imposed and torque reduction is performed. As a result, increase of the slip ratio is suppressed and free spinning of the driving wheel is prevented by setting the torque setting value Tₛ appropriately.

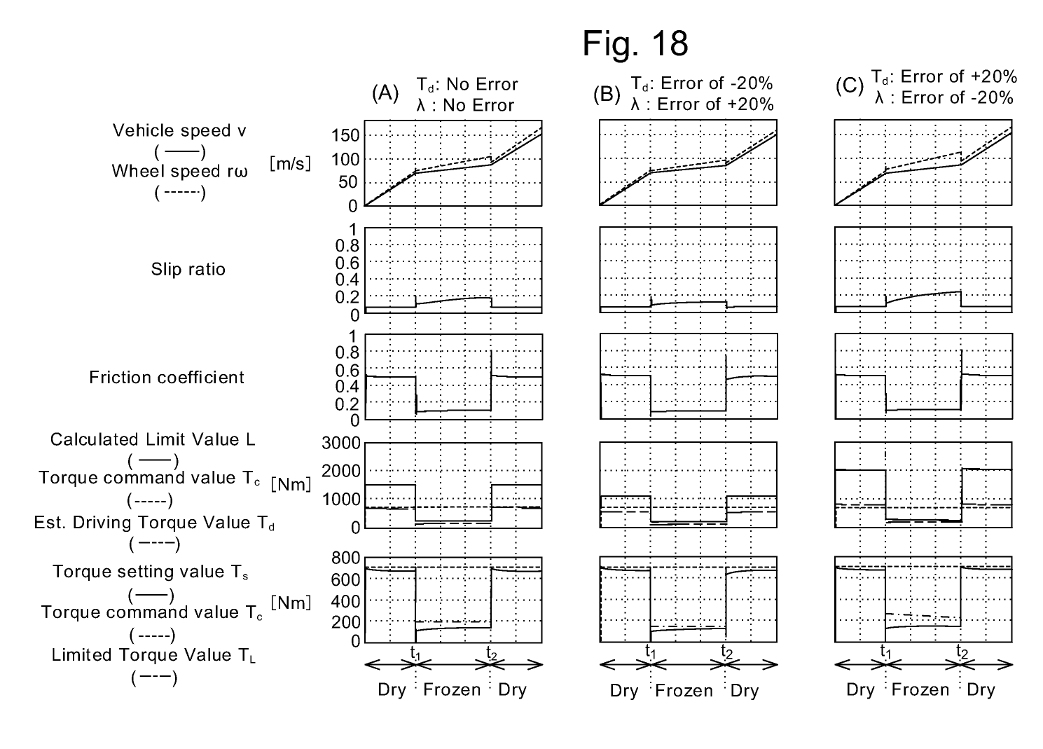

The results of simulations of anti-slip performance when the feedback gain kₚ is calculated by using Equation (21), in case when errors are included in the estimated slip ratio λ and in the estimated driving torque T_{d}, are shown in FIG. 18, along with comparison examples for when no errors are present. As will be understood by comparison of FIG. 18 with FIG. 12, when the feedback gain kₚ is calculated by using Equation (21), even if errors are included in the estimated slip ratio and in the estimated driving torque T_{d}, the results are obtained that are close to those obtained when slippage suppression is performed when no errors are present. Note that the conditions for these simulations were the same as in the case of FIG. 12 described above.

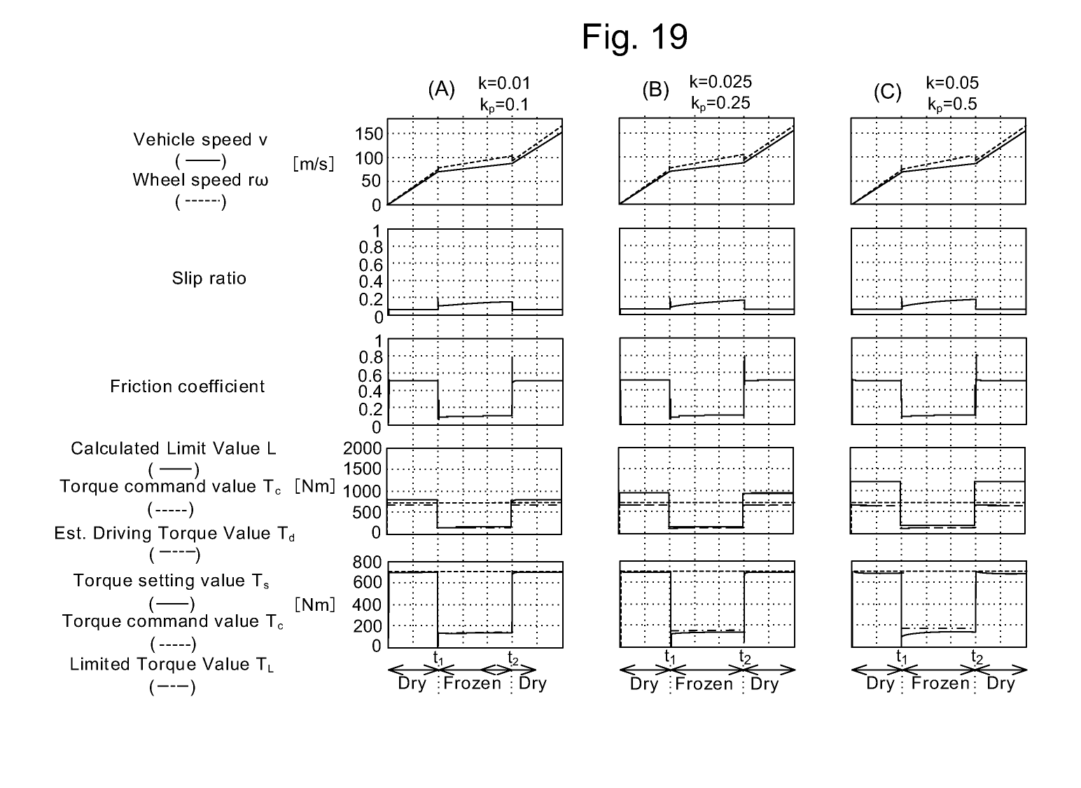

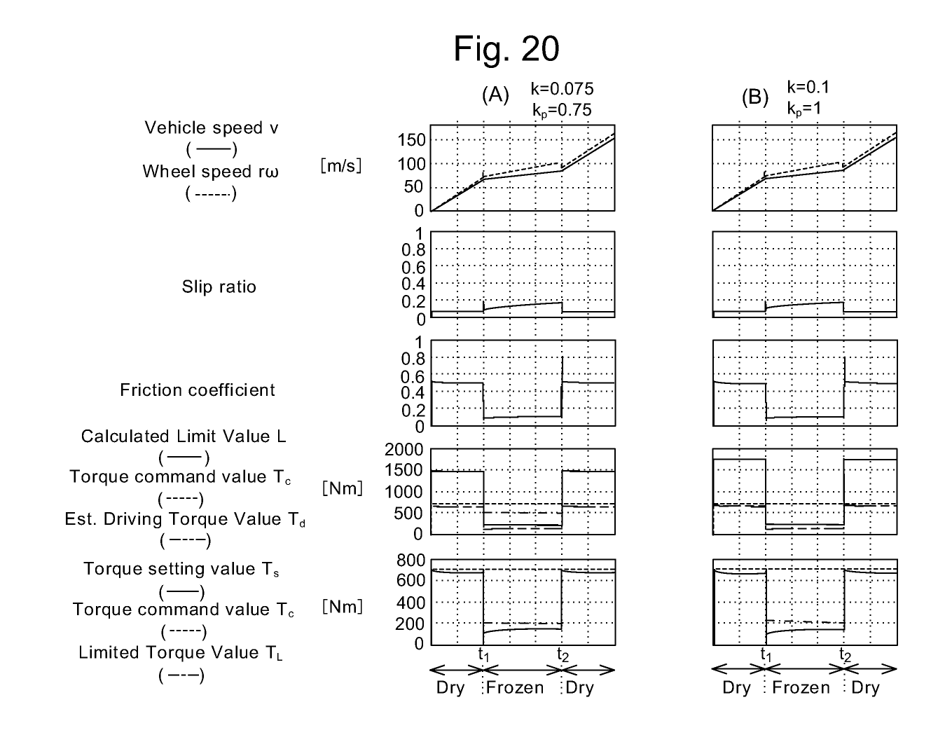

The results of anti-slip performance simulations for various combinations of values of the limiter coefficient k and the feedback gain kₚ that satisfy the relationship of Equation (21) are shown in FIGS. 19 and 20. As will be understood from FIGS. 19 and 20, two stages of reduction are performed: reduction from the torque command value T_{c} to the limited torque value T_{L}, and reduction from the limited torque value T_{L} to the torque setting value Tₛ. And, irrespective of the type of combination of the limiter coefficient k and the feedback gain kₚ, finally a torque setting value Tₛ of the same level is reached, and the slip ratio also reaches the same level. Note that the conditions for these simulations were the same as in the case of FIG. 11(C) described above.

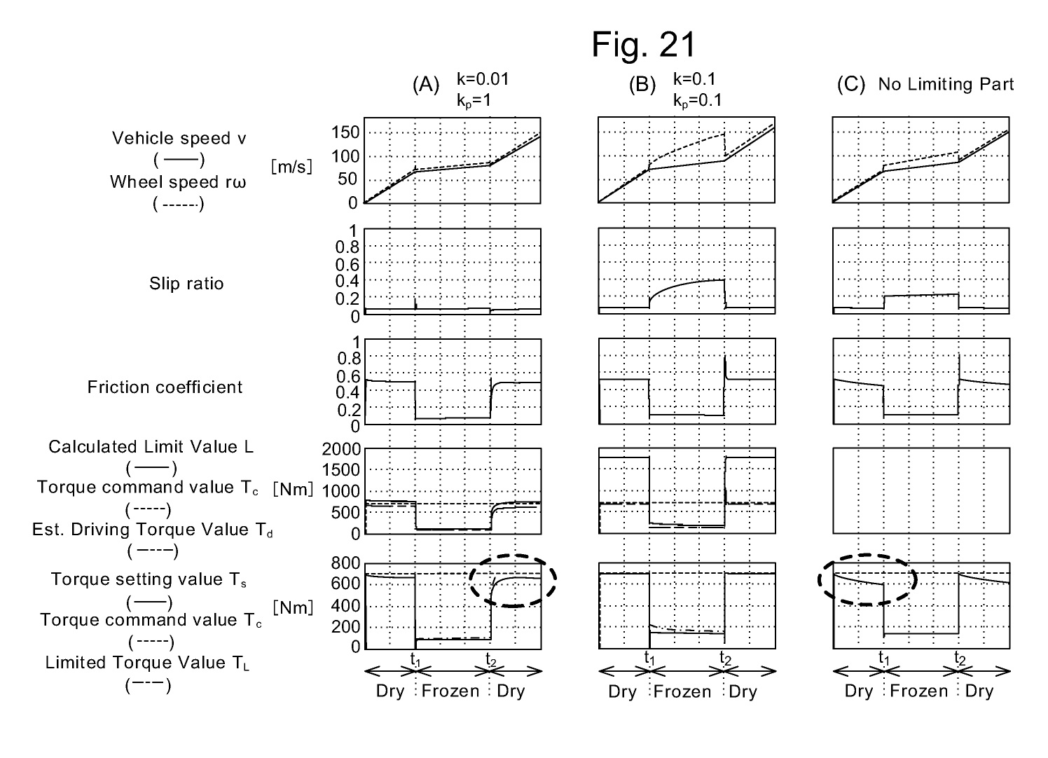

For the purposes of comparison, the results of simulations of anti-slip performance for various combinations of values of the limiter coefficient k and the feedback gain kₚ that do not satisfy the relationship of Equation (21) are shown in FIGS. 21(A) and 21(B). As shown in FIGS. 21(A) and 21(B), when the relationship of Equation (21) is not satisfied, the torque reduction may be too strong so that the torque is undesirably diminished even on a dry road surface, or slippage suppression may be insufficient, which is also undesirable.

Moreover, the results of simulation of anti-slip performance when the feedback gain kₚ has the large value of “10” are shown in FIG. 21(C). As shown in FIG. 21(C), in this case, it is possible to keep down the slip ratio upon a frozen road surface. However, as will be understood from the change of the torque setting value Tₛ in the oval portion surrounded by the broken line, the torque setting value T, is greatly decreased on a dry road surface, which is undesirable.

Note that the conditions for the simulations that provided the FIG. 21 results were the same as in the case of FIG. 11(C) described above.

### <Operation>

Next, the operation of the traction control device 700A having a configuration such as that described above will be explained with attention principally being directed to the processing performed by the control part 740A when a command has been issued to the effect that traction control is to be performed (hereinafter this is also sometimes termed “traction control mode processing”).

Note that it will be supposed that the torque command value generation part 810, the acceleration detection part 820, the error estimation part 830, and the motor drive system 900 have already started their operation, and that the torque command value T_{c}, the acceleration α, the estimated error ratios a and b, the rotational position θ, and the detected current value I_{D} are being successively sent to the traction control device 700A (refer to FIG. 5).

In the traction control device 700A, the movement speed acquisition part 710 acquires the movement speed v by performing time integration of the acceleration a sent from the acceleration detection part 820. And the movement speed acquisition part 710 successively sends the movement speed v that it has thus acquired to the control part 740A and to the error estimation part 830 (refer to FIG. 5).

Moreover, the rotational speed acquisition part 720 acquires the rotational speed ω by performing time differentiation of the rotational position θ sent from the rotational position detection part 940. And the rotational speed acquisition part 720 successively sends the rotational speed ω that it has thus acquired to the control part 740A and to the error estimation part 830 (refer to FIG. 5).

Furthermore, the actual torque value acquisition part 730 performs acquisition of the actual torque value Tₘ by calculating the actual torque value Tₘ on the basis of the detected current value I_{D} sent from the current detection part 950. And the actual torque value acquisition part 730 successively sends the actual torque value Tₘ that it has thus acquired to the control part 740A (refer to FIG. 5).

### <<Processing in the Traction Control Mode>>

In the traction control mode processing, the limiting part 741 in the control part 740A calculates the limited torque value T_{L}.

During the calculation of the limited torque value T_{L}, the limiter coefficient calculation part 761 calculates the limiter coefficient k according to the above Equation (16), on the basis of the estimated error ratios a and b sent from the error estimation part 830. And the limiter coefficient calculation part 761 sends the limiter coefficient k that it has thus calculated to the limit value calculation part 764 and to the feedback part 742 (refer to FIG. 8).

Furthermore, the slip ratio estimation part 762 performs slip ratio estimation by calculating the estimated slip ratio λ according to the above Equation (5), on the basis of the movement speed v sent from the movement speed acquisition part 710 and the rotational speed ω sent from the rotational speed acquisition part 720. And the slip ratio estimation part 762 successively sends the slip ratio λ that has thus been estimated to the limit value calculation part 764 (refer to FIG. 8).

Moreover, the driving torque estimation part 763 performs driving torque estimation by calculating the estimated driving torque T_{d} by passing the value determined according to the above Equation (10) on the basis of the rotational speed ω sent from the rotational speed acquisition part 720 and the actual torque value Tₘ sent from the actual torque value acquisition part 730 through a low pass filter (i.e. an LPF). And the driving torque estimation part 763 successively sends the estimated driving torque T_{d} to the limit value calculation part 764 and to the error estimation part 830 (refer to FIG. 8).

Note that the driving torque estimation part 763 sends the time differentiated value (dω/dt) of the rotational speed ω that has been calculated at an intermediate stage of the calculation of the estimated driving torque T_{d} to the feedback part 742 (refer to FIG. 8).

Moreover, the limit value calculation part 764 calculates the limit value L according to Equation (11), on the basis of the limiter coefficient k sent from the limiter coefficient calculation part 761, the estimated slip ratio λ sent from the slip ratio estimation part 762, and the estimated driving torque T_{d} sent from the driving torque estimation part 763. And the limit value calculation part 764 successively sends the limit value L that it has thus calculated to the limiter part 765 (refer to FIG. 8).

The limiter part 765 calculates the limited torque value T_{L} as described above on the basis of the limit value L sent from the limit value calculation part 764, thus performing limitation control upon the torque command value T_{c}. And the limiter part 765 successively sends the limited torque value T_{L} that it has thus calculated to the torque setting value calculation part 743A (refer to FIG. 8).

The feedback part 742 calculates a feedback torque value T_{f} in parallel with this calculation of the limited torque value T_{L} by the limiting part 741.

During calculation of the feedback torque value T_{f}, the adhesive model part 771 calculates the back-calculated torque value Tᵣ, according to Equation (17) on the basis of the time differentiated value (dω/dt) of the rotational speed ω sent from the limiting part 741. And the adhesive model part 771 sends the back-calculated torque value Tₙ that has thus been calculated to the subtraction part 772 (refer to FIG. 15).

Subsequently, the subtraction part 772 calculates the differential value Tₕ according to Equation (18) on the basis of the back-calculated torque value Tₙ sent from the adhesive model part 771 and the actual torque value Tₘ sent from the actual torque acquisition part 730. And the subtraction part 772 sends the differential torque value Tₕ that has thus been calculated to the LPF part 773 (refer to FIG. 15).

Next, the LPF part 773 performs filtering processing upon the differential torque value Tₕ that has been sent from the subtraction part 772, and thereby calculates the after-filtering torque value T_{af}. And the LPF part 773 sends the after-filtering torque value T_{af} that has thus been calculated to the multiplication part 775 (refer to FIG. 15).

In parallel with this calculation of the after-filtering torque value T_{af}, on the basis of the limiter coefficient k sent from the limiting part 741, the feedback gain calculation part 774 calculates the feedback gain kₚ according to Equation (21). And the feedback gain calculation part 774 sends the feedback gain kₚ that has thus been calculated to the multiplication part 775.

Next, the multiplication part 775 calculates the feedback torque value T_{f} according to Equation (20), on the basis of the after-filtering torque value T_{af} sent from the LPF part 773 and the feedback gain kₚ sent from the feedback gain calculation part 774. And the multiplication part 775 sends the feedback torque value T_{f} that has thus been calculated to the torque setting value calculation part 743A.

Upon receipt of the limited torque value T_{L} sent from the limiting part 741 and the feedback torque value T_{f} sent from the feedback part 742, the torque setting value calculation part 743A calculates the torque setting value Tₛ according to Equation (9). And the torque setting value calculation part 743A sends the torque setting value Tₛ that has thus been calculated to the motor drive system 900 (refer to FIG. 7).

### <<Processing in the Non-Traction Control Mode>>

In the non-traction control mode processing, the limiter part 765 of the limiting part 741 sends the torque command value T_{c} to the torque setting value calculation part 743A as the limited torque value T_{L}. Note that, in the case of the non-traction control mode processing as well, the driving torque estimation part 763 of the limiting part 741 performs calculation of the estimated driving torque T_{d}, and sends the estimated driving torque T_{d} that has thus been calculated to the error estimation part 830.

Moreover, in the non-traction control mode processing, the feedback part 742 takes the feedback torque value T_{f} as being “0”, and sends this to the torque setting value calculation part 743A.

As a result, the torque setting value T, calculated by the torque setting value calculation part 743A is the same as the torque command value T_{c}. Due to this, in the non-traction control mode processing, the torque command value T_{c} is sent from the control part 740A to the motor drive system 900 as the torque setting value Tₛ just as it is without modification.

And, on the basis of the torque setting value Tₛ sent from the traction control device 700A, current corresponding to the torque setting value Tₛ is supplied by the motor drive system 900 to the motor 930. As a result, the motor 930 is driven with a torque value that corresponds to the torque setting value Tₛ.

As has been explained above, in the first embodiment, the movement speed v of the moving body MV having the driving wheel that is driven by the motor 930, the rotational speed ω of the driving wheel of the moving body MV, and the actual torque value Tₘ generated by the motor 930 are acquired. Here, the movement speed v, the rotational speed ω, and the actual torque value Tₘ can be acquired quickly.

Subsequently, on the basis of the movement speed v and the rotational speed ω, the limiting part 741 in the control part 740A estimates the estimated slip ratio λ of the driving wheel by using Equation (5), with which quick calculation is possible. Moreover, on the basis of the rotational speed ω and the actual torque value Tₘ, the limiting part 741 estimates the estimated driving torque Td of the driving wheel by using Equation (10), with which quick calculation is possible.

Next, on the basis of the estimated slip ratio λ and the estimated driving torque T_{d}, the limiting part 741 calculates the limit value L for the torque command value T_{c} by using Equation (11), with which quick calculation is possible. And the limiting part 741 performs limitation processing upon the torque command value T_{c} by using this limit value L, and thereby calculates the limited torque value T_{L}.

In parallel with this calculation of the limited torque value T_{L}, on the basis of the time differentiated value (dω/dt) of the rotational speed ω at this time point and the actual torque value Tₘ, the feedback part 742 in the control part 740A calculates the feedback torque value T_{f} by using Equations (17), (18), (20), and (21) in an appropriate manner, with which quick calculation is possible. Note that the feedback part 742 calculates the feedback torque value T_{f} on the basis of an adhesive model.

Subsequently, on the basis of the limited torque value T_{L} and the feedback torque value T_{f}, the torque setting value calculation part 743A calculates the torque setting value Tₛ according to Equation (9). And the torque setting value calculation part 743A sends the torque setting value Tₛ that has thus been calculated to the motor drive system 900.

Due to this, according to the first embodiment, reduction of the torque setting value Tₛ is performed by limitation of the torque setting value Tₛ by feed forward control by the limiting part 741, and also by feedback control by the feedback part 742. Therefore, according to the first embodiment, it is possible for both prevention of increase of the slip ratio λ upon a frozen road surface, and also output of sufficient torque upon a dry road surface, to be made compatible.

Moreover, in the first embodiment, the limiter coefficient k is calculated according to Equation (16), on the basis of the estimated error ratio a of the estimated driving torque T_{d} and the estimated error ratio b of the estimated slip ratio λ. And the feedback gain kₚ for the feedback part 742 is calculated according to Equation (21). Due to this, it enables to perform traction control in an effective manner, even if errors are included in the estimated driving torque T_{d} and/or in the estimated slip ratio λ.

### The Second Embodiment

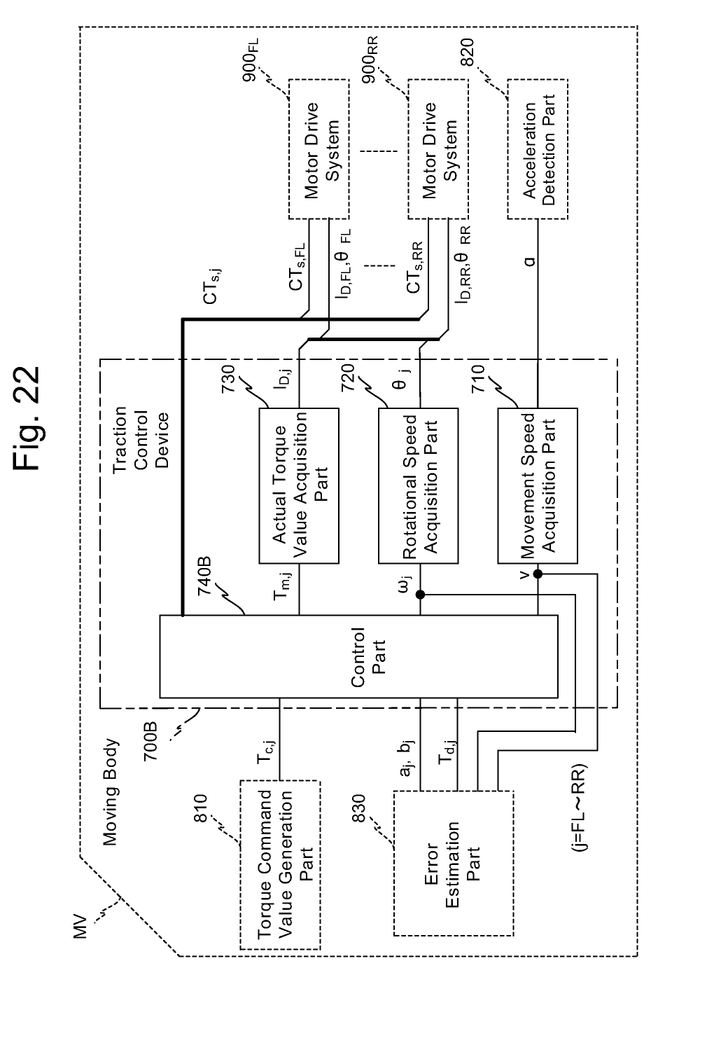

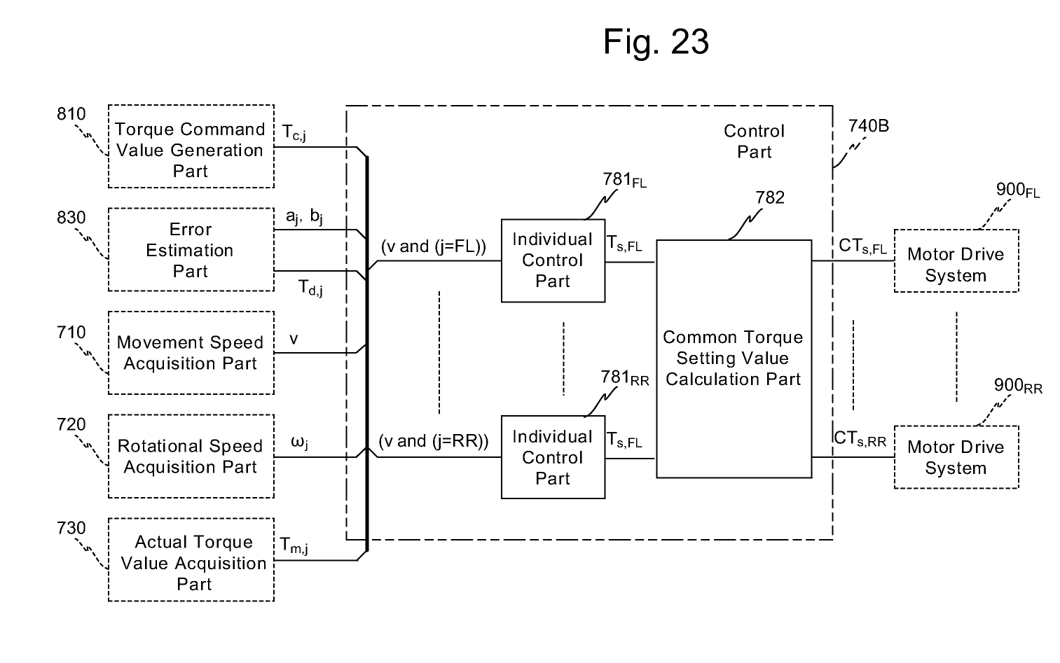

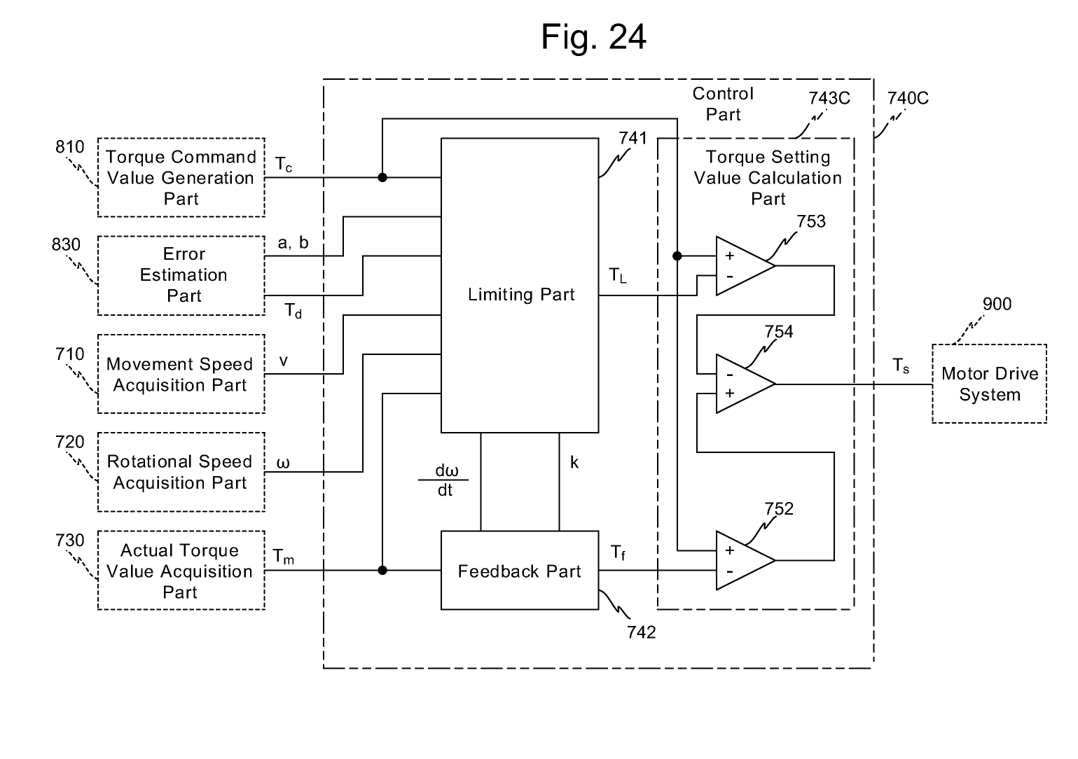

Next, the second embodiment of the present invention will be explained with principal reference to FIGS. 22 and 23.

The placement and the configuration of a traction control device 700B according to the second embodiment are shown in FIG. 22. As shown in FIG. 22, the traction control device 700B is arranged within a moving body MV that has four driving wheels that can be driven independently of one another: a left front driving wheel WH_{FL}, a right front driving wheel WH_{FR}, a left rear driving wheel WH_{RL}, and a right rear driving wheel WH_{RR}.

In addition to the traction control device 700B, a torque command value generation part 810, an acceleration detection part 820, an error estimation part 830, and motor drive systems 900_{FL} through 900_{RR} are provided to the moving body MV. Here, each of the motor drive systems 900 (where j=FL-RR) is configured in a similar manner to the motor drive system 900 explained in the first embodiment described above.

In other words, each motor drive system 900 comprises a drive control part 910ⱼ that has a similar function to that of the drive control part 910, an inverter 920ⱼ that has a similar function to that of the inverter 920, and a motor 930ⱼ that has a similar function to that of the motor 930. Moreover, each motor drive system 900ⱼ comprises a rotational position detection part 940ⱼ that has a similar function to that of the rotational position detection part 940 and a current detection part 950ⱼ that has a similar function to that of the current detection part 950.

Here, the drive control part 910ⱼ calculates a drive voltage on the basis of a torque setting value CT_{s,j} sent from the traction control device 700B, a rotational position θⱼ detected by the rotational position detection part 940ⱼ, and a detected current value I_{D,j} detected by the current detection part 950ⱼ. And the drive control part 910ⱼ sends the drive voltage that has thus been calculated to the inverter 920ⱼ.

Moreover, the rotational position detection part 940ⱼ detects the rotational position θⱼ of the motor 930ⱼ. And the rotational position detection part 940ⱼ sends the rotational position θⱼ that has thus been detected to the traction control device 700B and to the drive control part 910ⱼ.

Furthermore, the current detection part 950ⱼ detects the value of the current flowing to the motor 930ⱼ. And the current detection part 950ⱼ sends the current value that has thus been detected to the traction control device 700B and to the drive control part 910ⱼ as the detected current value I_{D,j}.

Note that torque command values T_{c,FL} through T_{c,RR} corresponding respectively to the four driving wheels WH_{FL} through WH_{RR} are sent from the torque command value generation part 810 to the traction control device 700B.

Moreover, the error estimation part 830 estimates estimated error ratios a_{FL} through a_{RR} and estimated error ratios b_{FL} through b_{RR} corresponding respectively to the four driving wheels WH_{FL} through WH_{RR}, and sends the results of these estimations to the traction control device 700B.

### <Configuration of the Traction Control Device 700B>

As shown in FIG. 22, as compared with the traction control device 700A in the first embodiment described above, the traction control device 700B differs by comprising a control part 740B, instead of the control part 740A. In the following, the explanation will principally concentrate upon this point of difference.

Note that the rotational speed acquisition part 720 in the second embodiment receives the rotational positions θⱼ sent from the rotational position detection part 940ⱼ. And the rotational speed acquisition part 720 performs time differentiation of the rotational positions θ, and thereby acquires the rotational speeds ωⱼ. The rotational speeds ωⱼ that have been acquired in this manner are sent to the control part 740B and to the error estimation part 830.

Moreover, the actual torque value acquisition part 730 in the second embodiment receives the detected current values I_{D,j} sent from the current detection parts 950. Subsequently, the actual torque value acquisition part 730 calculates the motor current values I_{m,j} on the basis of these detected current values I_{D,j}. Note that the motor current values I_{m,j} represent the absolute magnitudes of the detected current values I_{D,j}, in other words I_{m,j}=|I_{D,j}|.

Next, by calculating the actual torque values T_{m,j} by using Equation (1) given above, the actual torque value acquisition part 730 acquires the actual torque values T_{m,j}. The actual torque values T_{m,j} that have been acquired in this manner are sent to the control part 740B.

As shown in FIG. 23, the control part 740B comprises individual control parts 781_{FL} through 781_{RR} and a common torque setting value calculation part 782.

Each of the individual control parts 781ⱼ (where j=FL through RR) has a similar configuration to that of the control part 740A described above. Each of the individual control parts 781ⱼ receives the torque command value T_{c,j} sent from the torque command value generation part 810 and the estimated error ratios aⱼ and bⱼ sent from the error estimation part 830. Subsequently, the individual control part 781ⱼ performs limitation control upon the torque command value T_{c,j} on the basis of the speed of movement v, the rotational speed ωⱼ, and the actual torque value T_{m,j}, and thereby calculates the limited torque value T_{L,j}. Moreover, the individual control part 781ⱼ generates a feedback torque T_{f,j} on the basis of the actual torque value T_{m,j}, the time differentiated value (dωⱼ/dt) of the rotational speed ωⱼ that was obtained at an intermediate stage of the calculation of the limited torque value T_{L,j}, and the limiter coefficient kⱼ. And the individual control part 781ⱼ calculates an individual torque setting value T_{s,j} on the basis of the feedback torque T_{f,j} and the limited torque value T_{L,j}, and sends the individual torque setting value T_{s,j} that has thus been calculated to the common torque setting value calculation part 782.

Note that, if no command is issued to the effect that traction control should be performed, then the individual control parts 781ⱼ are adapted to send the torque command values T_{c,j} to the common torque setting value calculation part 782 as the individual torque setting values T_{s,j}.

Moreover, the individual control part 781ⱼ sends the estimated driving torques T_{d,j} to the error estimation part 830. Note that the individual control part 781ⱼ performs calculation of the estimated driving torque T_{d,j} and to send the estimated driving torque T_{d,j} that has thus been calculated to the error estimation part 830, irrespective of whether or not a command has been issued to the effect that traction control is to be performed.

The common torque setting value calculation part 782 receives the individual torque setting values T_{s,j} sent from the individual control parts 781. And, if no command has been issued to the effect that traction control is to be performed, then the common torque setting value calculation part 782 sends the individual torque setting value T_{s,j} to the motor drive system 900 as a torque setting value CT_{s,j}.

On the other hand, if a command has been issued to the effect that traction control is to be performed, then the common torque setting value calculation part 782 finds the minimal value among the individual torque setting values T_{s,FL} through T_{s,RR}. Subsequently, the common torque setting value calculation part 782 sets all of the torque setting values CT_{s,FL} through CT_{s,RR} to the minimal value T_{s,min} that has thus been found. And the common torque setting value calculation part 782 sends to the motor drive system 900ⱼ the torque setting values CT_{s,j} that have thus been set to the minimal value T_{s,min}.

### <Operation>

Next, the operation of the traction control device 700B having the configuration described above will be explained, with attention being principally concentrated upon the traction control mode processing performed by the control part 740B when a command has been issued for traction control to be performed.

Note that it will be supposed that the torque command value generation part 810, the acceleration detection part 820, the error estimation part 830, and the motor drive systems 900 have already started their operation, and that the torque command values T_{c,j}, the acceleration α, the estimated error ratios aⱼ and bⱼ, the rotational positions θⱼ, and the detected current values I_{D,j} are being successively sent to the traction control device 700B (refer to FIG. 22).

In the traction control device 700B, the movement speed acquisition part 710 acquires the movement speed v by performing time integration of the acceleration a sent from the acceleration detection part 820. And the movement speed acquisition part 710 successively sends the movement speed v that it has thus acquired to the control part 740B and to the error estimation part 830 (refer to FIG. 22).

Moreover, the rotational speed acquisition part 720 acquires the rotational speeds ωⱼ by performing time differentiation of the rotational positions θⱼ sent from the rotational position detection parts 940. And the rotational speed acquisition part 720 successively sends the rotational speeds ωⱼ that it has thus acquired to the control part 740B and to the error estimation part 830 (refer to FIG. 22).

Furthermore, the actual torque value acquisition part 730 performs acquisition of the actual torque values T_{m,j} by calculating the actual torque values T_{m,j} on the basis of the detected current values I_{D,j} sent from the current detection part 950. And the actual torque value acquisition part 730 successively sends the actual torque values T_{m,j} that it has thus acquired to the control part 740B (refer to FIG. 22).

### <Processing in the Traction Control Mode>

In the traction control mode processing, the individual control parts 781ⱼ in the control part 740B calculate individual torque setting values T_{s,j} by performing processing similar to that performed by the control part 740A described above. And the individual control parts 781ⱼ send the individual torque setting values T_{s,j} that have thus been calculated to the common torque setting value calculation part 782.

Upon receipt of the individual torque setting values T_{s,FL} through T_{s,RR} sent from the individual control parts 781_{FL} through 781_{RR}, the common torque setting value calculation part 782 finds the minimal one of these individual torque setting values T_{s,FL} through T_{s,RR}. Subsequently, the common torque setting value calculation part 782 sets all of the torque setting values CT_{s,FL} through CT_{s,RR} to the minimal value T_{s,min} that has thus been found. And the common torque setting value calculation part 782 sends these torque setting values CT_{s,j} that have been thus set to the minimal value T_{s,min} to the motor drive systems 900.

Note that the individual control parts 781ⱼ send the estimated driving torques T_{d,j} that have been calculated at intermediate stages of calculation of the individual torque setting values T_{s,j} to the error estimation part 830.

### <Processing in the Non-Traction Control Mode>

In the non-traction control mode processing, the individual control parts 781ⱼ of the control part 740B send the torque command values T_{c,j} just as they are without modification as the individual torque setting values T_{s,j}. And the individual control parts 781ⱼ send these individual torque setting values T_{s,j} (=T_{c,j}) to the common torque value calculation part 782.

Upon receipt of the individual torque setting values T_{s,FL} through T_{s,RR} sent from the individual control parts 781_{FL} through 781_{RR}, the common torque value setting part 782 takes these individual torque setting values T_{s,FL} through T_{s,RR} just as they are without modification as the torque setting values CT_{s,FL} through CT_{s,RR}. Note that, in this case of the non-traction control mode processing as well, the individual control parts 781ⱼ perform calculation of the estimated driving torques T_{d,j}, and send the estimated driving torques T_{d,j} that have thus been calculated to the error estimation part 830.

Upon receipt of the individual torque setting values T_{s,FL} through T_{s,RR} sent from the individual control parts 781_{FL} through 781_{RR}, the common torque value setting part 782 sends these individual torque setting values T_{s,j} just as they are without modification to the motor drive systems 900 as the torque setting values CTₛ,. As a result, the torque command values T_{c,j} are sent to the motor drive systems 900 just as they are without modification.

And, on the basis of these torque setting values CT_{s,j} sent from the traction control device 700B, currents corresponding to these torque setting value CTₛ, are supplied by the motor drive systems 900 to the motors 930. As a result, the motors 930 are driven with actual torque values that correspond to the torque setting values CT_{s,j}.

As has been explained above, according to the second embodiment, in a similar manner to the case with the first embodiment described above, it is possible rapidly to implement control for performing stable traveling according to change of the state of the road surface, while still ensuring the required drive power.

Furthermore, with the second embodiment, the minimal one among the individually set torque values that are calculated for each of the plurality of driving wheels is taken as being the torque setting value for all of the plurality of driving wheels. In this case, it enables to ensure stable travelling, because it enables to suppress differences in the torque setting values between the plurality of driving wheels. For example, if the vehicle is traveling upon a road surface of which only the left side of the road is frozen, then, it enables to avoid torque unbalance between the left side and the right side, and to prevent change of the orientation of the moving body, because the torque setting value that is calculated by taking the driving wheels on the left side as subject is adapted for use with the driving wheels on the right side.

### Modification of the Embodiment

The present invention is not to be considered as being limited to the embodiments described above; modifications of various kinds are possible.

For example while, in the first and second embodiments, it was arranged to employ an acceleration sensor when acquiring the speed of movement, it may be acceptable to arrange to employ an optical type ground sensor.

Moreover while, in the first and second embodiments, the actual torque value Tₘ of the motor was obtained from Equation (1), it may be acceptable to arrange to calculate the actual torque value Tₘ by multiplying Tₛ by the torque response characteristic, as in the following Equation (22):

Tₘ=Tₛ·(1/(τ₁·s+1)) (22)

Here, the value τ₁ is the time constant of the torque response.

Furthermore, in the first and second embodiments, the traction control device did not include the error estimation part. By contrast, it may be acceptable to arrange for the traction control device to include the error estimation part.

Moreover, in the first and second embodiments, it was arranged to calculate the limiter coefficient on the basis of the estimated error range. By contrast, if the changes of the errors in the estimated slip ratio and the estimated driving torque are small, then it may be acceptable to arrange for the limiter coefficient to be a fixed value.

Yet further, instead of the control part 740A in the first embodiment, it may be acceptable to arrange to employ a control part 740C having a configuration such as shown in FIG. 24.

As compared to the control part 740A, the way in which the control part 740C is different is that, instead of the torque setting value calculation part 743A, it includes a torque setting value part 743C. The torque setting values calculation part 743C comprises subtraction parts 752, 753, and 754.

The subtraction part 752 receives the torque command value T_{c} sent from the torque command value generation part 810 and the feedback torque value T_{f} sent from the feedback part 742. And the subtraction part 752 calculates a first differential value (T_{c}−T_{f}).

The subtraction part 753 receives the torque command value T_{c} sent from the torque command value generation part 810 and the limited torque value T_{L} sent from the limiting part 741. And the subtraction part 753 calculates the second differential value (T_{c}−T_{L}).

The subtraction part 754 receives the first differential value (T_{c}−T_{f}) sent from the subtraction part 752 and the second differential value (T_{c}−T_{L}) sent from the subtraction part 753. And the subtraction part 754 calculates the torque setting value Tₛ according to the following Equation (23), and sends this torque setting value Tₛ that has thus been calculated to the motor drive system 900.

Tₛ=(T_{c}−T_{f})−(T_{c}−T_{L}) (23)

Here, since the right side of equation (23) is equal to (T_{L}−T_{f}), accordingly the torque setting value that is calculated by the control part 740C is the same as the torque setting value calculated by the control part 740A. Due to this, according to the traction control device in which the control part 740C is employed instead of the control part 740A, it enables to obtain similar beneficial effects to those obtained in the case of the first embodiment described above.

Note that it may be acceptable to arrange to implement a change to the second embodiment that is similar to the change from the control part 740A to the control part 740C.

Furthermore, in the first and second embodiments, a case was supposed in which the response speed of the driving torque of the driving wheel or wheels to the torque setting value or values was rapid, as in the case of an in-wheel motor. By contrast, it may be acceptable to apply the present invention to a case in which the response speed of the driving torque of the driving wheel or wheels to the torque setting value or values cannot be said to be rapid.

Note that it may be acceptable to arrange to execute partial or all of the functions of the traction control device in each of embodiments described above by building the traction control device in each of embodiments described above as a computer that functions as a calculation means comprising a central processing device (CPU: Central Processing Unit) and a DSP (Digital Signal Processor) and so on, and by that computer executing a program that has been prepared in advance. This program may be recorded upon a recording medium that can be read by the computer, such as a hard disk, a CD-ROM, a DVD or the like, or may be loaded from the recording medium and executed by that computer. Moreover, it would be acceptable to arrange for the program to be acquired by the method of being recorded upon a transportable medium such as a CD-ROM, a DVD or the like; or it could also be arranged for it to be acquired by the method of being distributed via a network such as the internet or the like.

### EXAMPLE

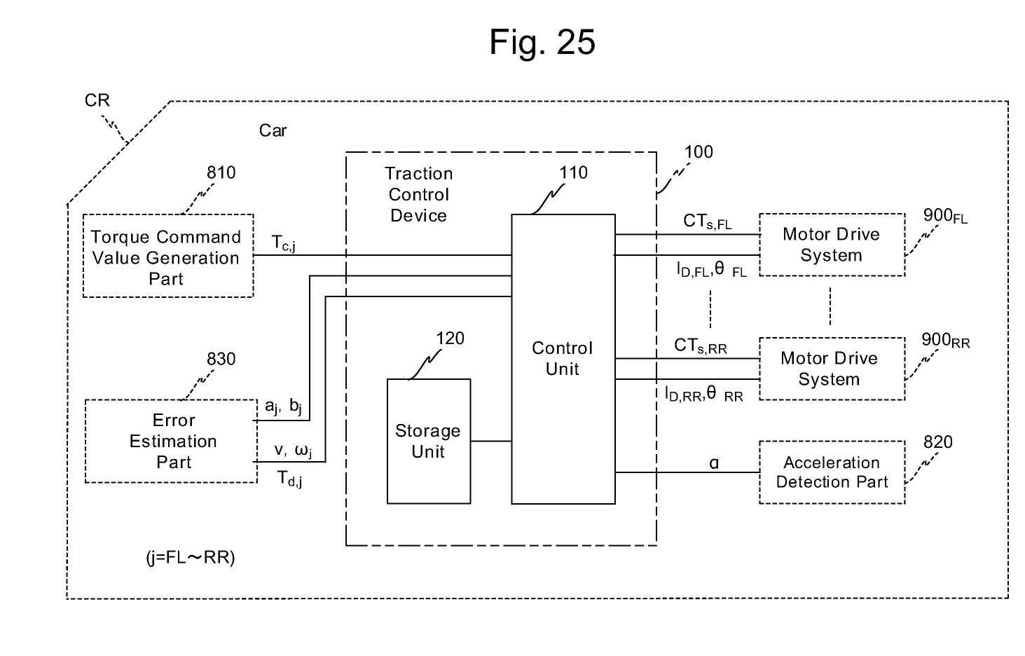

Next, an example of the present invention will be explained with principal reference to FIGS. 25 through 29. Note that, in the following explanation, and including the embodiments described above, the same reference symbols are appended to elements that are the same or equivalent, and duplicated explanation is omitted as much as possible.

### [Configuration]

The configuration of a traction control device 100 according to the example is schematically shown in FIG. 25. The traction control device 100 is one version of the traction control device 700B according to the second embodiment described above.

As shown in FIG. 25, the traction control device 100 is arranged within a vehicle CR, which corresponds to the above moving body MV. Note that the vehicle CR comprises four driving wheels that can be independently driven one another: a left front driving wheel WH_{FL}, a right front driving wheel WH_{FR}, a left rear driving wheel WH_{RL}, and a right rear driving wheel WH_{RR}.

In addition to the traction control device 100, a torque command value generation part 810, an acceleration detection part 820, an error estimation part 830, and motor drive systems 900_{FL} through 900_{RR} are provided to the vehicle CR. Here, each of the motor drive systems 900ⱼ (where j=FL to RR) has a similar configuration to that of the motor drive systems 900ⱼ explained above in connection with the second embodiment.

### <Configuration of the Traction Control Device 100>

The traction control device 100 comprises a control unit 110 and a storage unit 120.

The control unit 110 comprises a central processing device (CPU) and a DSP (Digital Signal Processor) as a calculation means. And the control unit 110 performs, by executing a program, to fulfill the functions of the movement speed acquisition part 710, the rotational speed acquisition part 720, the actual torque value acquisition part 730, and the control part 740B in the second embodiment.

The program executed by the control unit 110 is stored in a storage unit 120, and is loaded from the storage unit and executed. It would be acceptable to arrange for the program to be acquired by the method of being recorded upon a transportable recording medium such as a CD-ROM or a DVD or the like; or it may also be acquired by the method of being distributed via a network such as the internet or the like.

Note that the processing performed by the control unit 110 will be described hereinafter.

Information and data of various types for use by the control unit 110 are stored in the storage unit 120 mentioned above. The program that is executed by the control unit 110 is included in this information and data. The control unit 110 is adapted to be capable of accessing the storage unit 120.

<Configurations of the Drive Control Parts 910ⱼ and of the Current Detection Parts 950ⱼ>

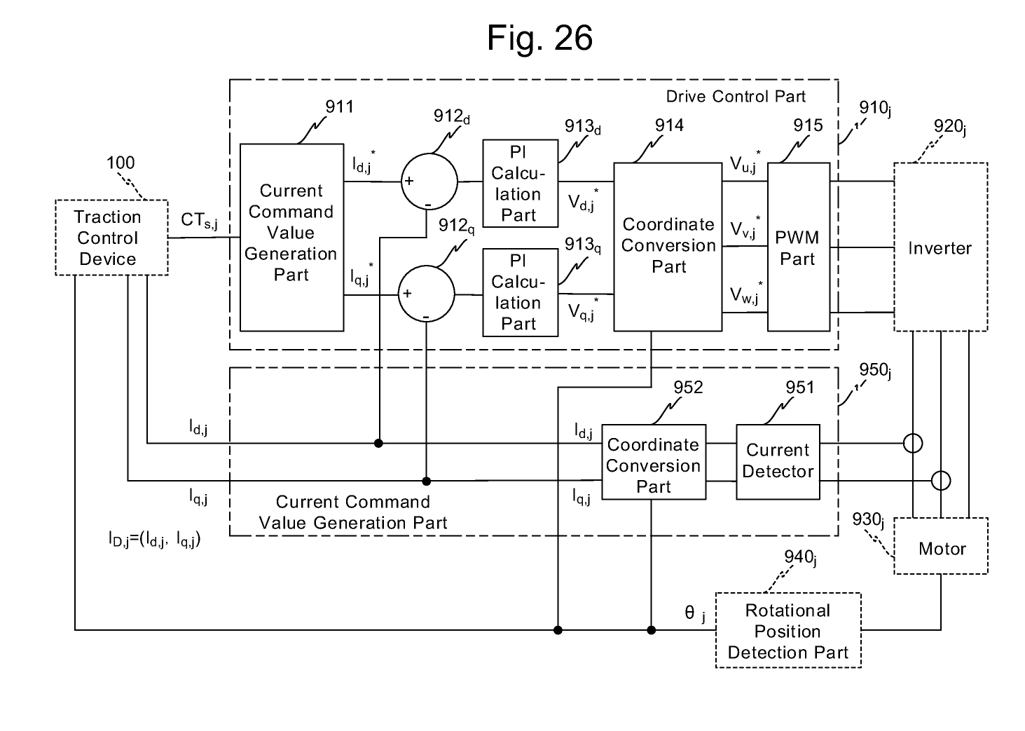

Now, one of the drive control parts 910ⱼ and one of the current detection parts 950ⱼ of the example will be explained in more detail with reference to FIG. 26. Note that, in the example, the motors 930ⱼ are three-phase motors.

First, the drive control part 910ⱼ will be explained. The drive control part 910ⱼ control the motor 930ⱼ by vector control. The drive control part 910ⱼ having the function comprises a current command value generation part 911, subtraction parts 912_{d} and 912_{q}, and proportional integral (PI) calculation parts 913_{d} and 913_{q}. Moreover, the drive control part 910ⱼ comprises a coordinate conversion part 914 and a pulse width modulation (PWM) part 915.

The current command value generation part 911 receives the torque setting value CT_{s,j} sent from the traction control device 100. And the current command value generation part 911 generates a d axis current command value I_{d,j}* and a q axis current command value I_{q,j}* for generating a motor torque equal to the torque setting value CT_{s,j}. The d axis current command value I_{d,j}* generated in this manner is sent to the subtraction part 912_{d}, and the q axis current command value L_{q,j}* is sent to the subtraction part 912_{q}.

The subtraction part 912_{d} receives the d axis current command value I_{d,j}* sent from the current command value generation part 911. And the subtraction part 912_{d} subtracts the d axis detected current value I_{d,j} from the d axis current command value I_{d,j}*. The result of the subtraction by the subtraction part 912_{d} is sent to the PI calculation part 913_{d}.

Similarly, the subtraction part 912_{q} receives the q axis current command value I_{q,j}* sent from the current command value generation part 911. And the subtraction part 912_{q} subtracts the q axis detected current value I_{q,j} from the q axis current command value I_{q,j}*. The result of the subtraction by the subtraction part 912_{d} is sent to the PI calculation part 913_{q}.

The PI calculation part 913_{d} receives the subtraction result sent from the subtraction part 912_{d}. And the PI calculation part 913_{d} performs proportional integral calculation on the basis of the subtraction result, and thereby calculates the d axis voltage command value V_{d,j}*. This d axis voltage command value V_{d,j}* that has thus been calculated by the PI calculation part 913_{d} is sent to the coordinate conversion part 914.

The PI calculation part 913_{q} receives the subtraction result sent from the subtraction part 912_{q}. And the PI calculation part 913_{q} performs proportional integral calculation on the basis of the subtraction result, and thereby calculates the q axis voltage command value V_{q,j}*. This q axis voltage command value V_{q,j}* that has thus been calculated by the PI calculation part 913_{q} is sent to the coordinate conversion part 914.

The coordinate conversion part 914 receives the d axis voltage command value V_{d,j}* sent from the PI calculation part 913_{d} and the q axis voltage command value V_{q,j}* sent from the PI calculation part 913_{q}. And the coordinate conversion part 914 refers to the rotational position θⱼ sent from the rotational position detection part 940ⱼ, and calculates a u axis control voltage value V_{u,j}*, a v axis control voltage value V_{v,j}*, and a w axis control voltage value V_{w,j}* by performing coordinate conversion upon the d axis voltage command value V_{d,j}* and the q axis voltage command value V_{q,j}*. The results of the calculation by the coordinate conversion part 914 are sent to the PWM part 915.

The PWM part 915 receives the three-phase control voltages sent from the coordinate conversion part 914. Then the PWM part 915 performs pulse width modulation upon these three-phase control voltages, and thereby generates three-phase PWM signals. The three-phase PWM signals that have been generated in this manner are sent to the inverter 920ⱼ.

Next, the current detection part 950 will be explained. The current detection parts 950 comprises a current detector 951 and a coordinate conversion part 952.

The current detector 951 detects the value of the u axis current values and the value of the v axis current values flowing to the motor 930ⱼ. And the current detector 951 sends the results of this detection to the coordinate conversion part 952 as a u axis detected current value L_{u,j} and a v axis detected current value I_{v,j}. Note that, while it may be acceptable also to detect the w axis current value (I_{w,j}), it is also possible to manage without detecting the w axis current value (I_{w,j}), because the relationship “I_{u,j}+I_{v,j}+I_{w,j}” holds.

The coordinate conversion part 952 receives the u axis detected current value I_{u,j} and the v axis detected current value I_{v,j} sent from the current detector 951. And the coordinate conversion part 952 refers to the rotational position θⱼ sent from the rotational position detection part 940ⱼ, and calculates a d axis detected current value I_{d,j} and a q axis detected current value L_{q,j}*, by performings coordinate conversion upon the u axis detected current value I_{u,j} and the v axis detected current value I_{v,j}. The results of this calculation by the coordinate conversion part 952 are sent to the traction control device 100 and to the drive control part 910ⱼ as detected current values I_{D,j}.

Note that the magnitudes |I_{D,j}| of I_{D,j} are calculated according to the following Equation (24):

|I_{D,j}|=(I_{d,j}²+I_{q,j}²)^{1/2} (24)

### [Operation]

Next, the operation for traction control by the traction control device 100 having the configuration described above will be described, with particular attention being directed to the processing performed by the control unit 110.

Note that it will be supposed that the torque command value generation part 810, the acceleration detection part 820, the error estimation part 830, and the motor drive system 900ⱼ have already started their operation, and that the torque command values T_{c,j}, the acceleration α, the estimated error ratios aⱼ and bⱼ, the rotational positions θⱼ, and the detected current values I_{D,j} are being successively sent to the traction control device 100 (refer to FIG. 22).

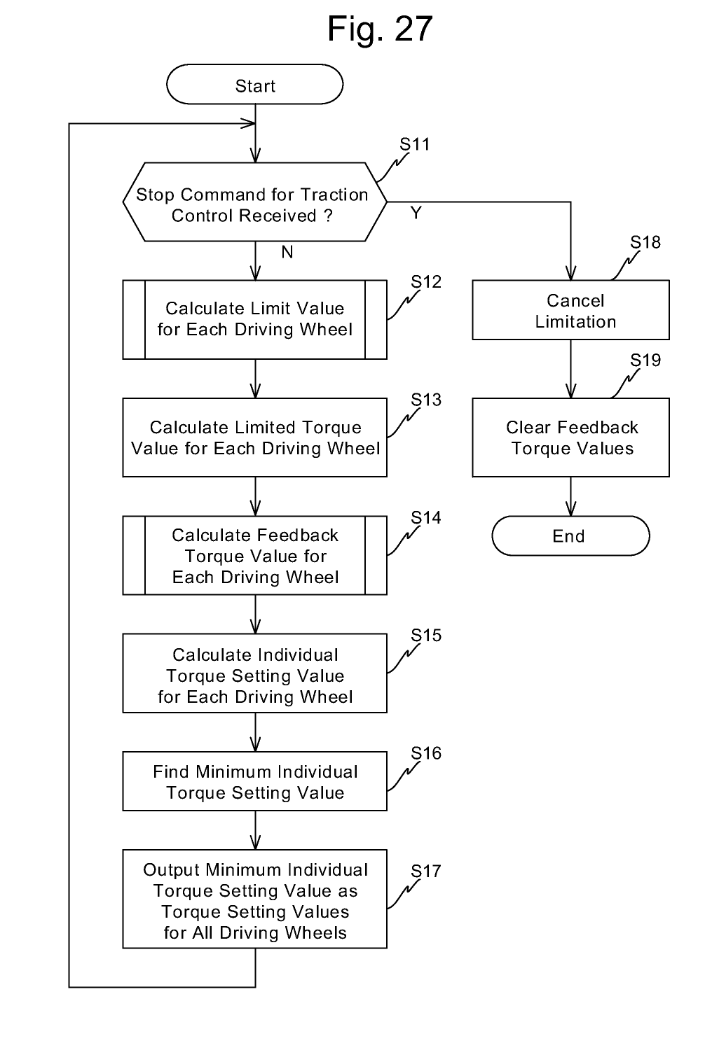

Traction control is started by the user inputting a start command for traction control via an input part not shown in the figures. During this traction control, as shown in FIG. 27, first in a step S11 the control unit 110 decides whether or not a stop command for traction control has been received via the that input part. If the result of the decision in the step S11 is negative (N in the step S11), then the flow of control proceeds to a step S12.

In the step S12, the control unit 110 calculates limit values L_{FL} through L_{RR} respectively corresponding to the four driving wheels WH_{FL} through WH_{RR}. Note that this processing for calculating the limit values L_{FL} through L_{RR} in the step S12 will be described hereinafter.

Subsequently, in a step S13, using the limit values L_{FL} through L_{RR} that have thus been calculated, the control unit 110 calculates limited torque values T_{L,FL} through T_{L,RR} corresponding respectively to the four driving wheels WH_{FL} through WH_{RR}.

And next, in a step S14, the control unit 110 calculates feedback torque values T_{f,FL} through T_{f,RR} corresponding respectively to the four driving wheels WH_{FL} through WH_{RR}. Note that this processing for calculation of the feedback torque values T_{f,FL} through T_{f,RR} in the step S14 will be described hereinafter.

Then in a step S15, on the basis of the limited torque values T_{L,FL} through T_{L,RR} and the feedback torque values T_{f,FL} through T_{f,RR}, the control unit 110 calculates individual torque setting values T_{s,FL} through T_{s,RR}. Subsequently, in a step S16, the control unit 110 finds the minimal value among these individual torque setting values T_{s,FL} through T_{s,RR}.

Next the control unit 110 sets all of the torque setting values CT_{s,FL} through T_{s,RR} to the minimal value T_{s,min} that has thus been found. And the control unit 110 successively outputs these torque setting values CT_{s,j} that have thus been set to the minimal value T_{s,min} to the motor drive systems 900 (refer to FIG. 25).

When the processing of a step S17 terminates, the flow of control returns to the step S11. And subsequently the processing of the steps S11 through S17 is repeated, until the result of the decision in the step S11 becomes affirmative.

When a stop command for traction control is received, the result of the decision in the step S11 becomes affirmative (Y in the step S11), the flow of control is transferred to a step S18. In the step S18, the control unit 110 performs limitation cancellation. Subsequently, in a step S19, clearing of the feedback torque values is performed. And then the traction control procedure terminates. As a result, the torque command values T_{c,j} are outputted to the motor drive systems 900ⱼ as the torque setting values CT_{s,j}.

<Processing for Calculation of the Limit Values L_{FL} through L_{RR}>

Next, the processing for calculation of the limit values L_{FL} through L_{RR} in the step S12 will be explained.

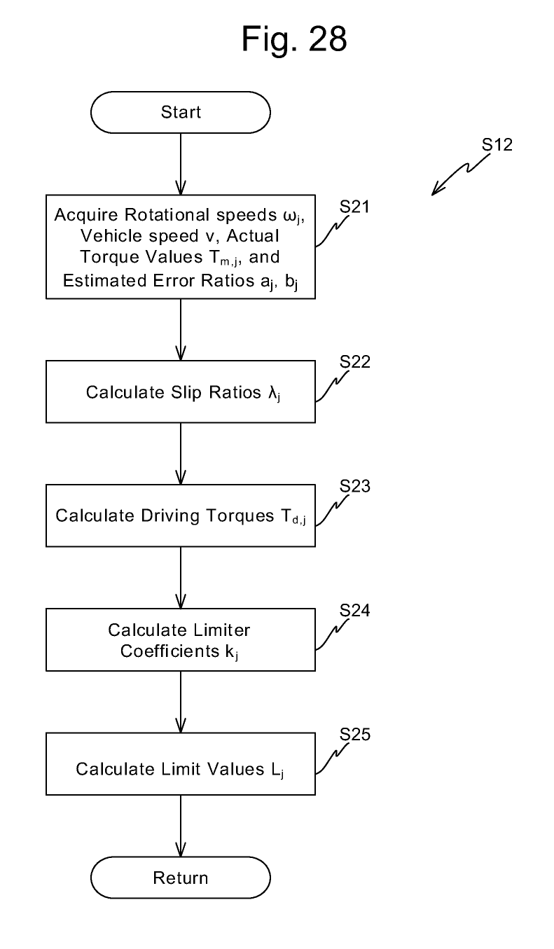

During this processing for calculation of the limit values Lⱼ, as shown in FIG. 28, first in a step S21 the control unit 110 gathers the acceleration α, the rotational positions θⱼ, the detected current values I_{D,j}, and the estimated error ratios aⱼ and bⱼ. And the control unit 110 acquires the vehicle speed v (i.e. the movement speed) by performing time integration of the acceleration α, acquires the rotational speeds ωⱼ by performing time differentiation of the rotational positions θⱼ, and also acquires the actual torque values T_{m,j} on the basis of the detected current values I_{D,j}.

Next, in a step S22, on the basis of the vehicle speed v and the rotational speeds ωⱼ, the control unit 110 performs slip ratio estimation by calculating the estimated slip ratios λⱼ according to Equation (5). And then in a step S23, on the basis of the rotational speeds ωⱼ and the actual torque values T_{m,j}, the control unit 110 performs driving torque estimation by calculating the estimated driving torques T_{d,j} by using Equation (10) given above.

Then in a step S24 the control unit 110 calculates the limiter coefficients kⱼ on the basis of Equation (16) given above. Subsequently, in a step S25, on the basis of the limiter coefficients kⱼ, the estimated slip ratios and the estimated driving torques T_{d,j}, the control unit 110 calculates the limit values Lⱼ by using Equation (12) given above.

When the processing of the step S25 terminates, the processing of the step S12 terminates. And then the flow of control is transferred to the step S13 in FIG. 27.

<Processing for Calculation of the Feedback Torque Values T_{f,FL} through T_{f,RR}>

Next, the processing for calculation of the feedback torque values T_{f,FL} through T_{f,RR} in the step S14 will be explained.

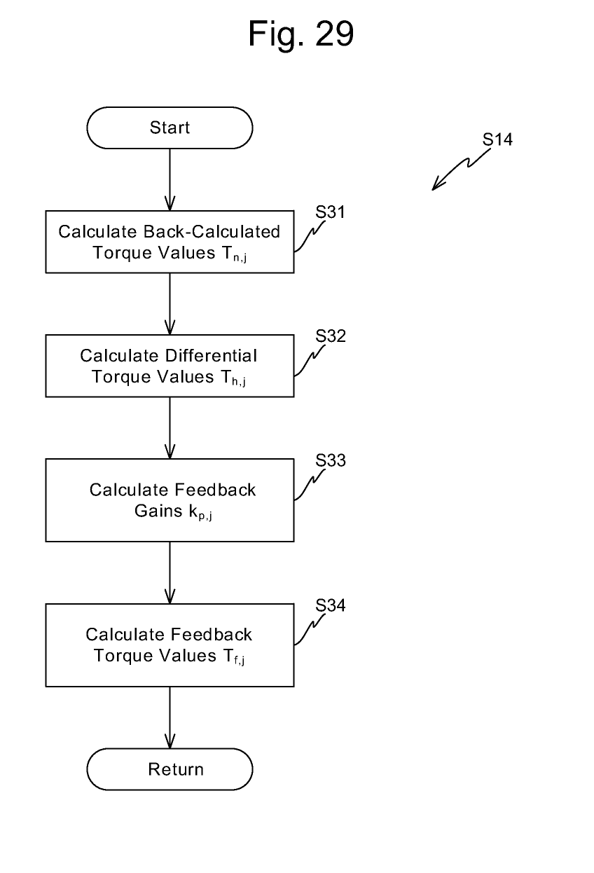

During this processing for calculation of the feedback torque values T_{f,FL} through T_{f,RR}, as shown in FIG. 29, first in a step S31, on the basis of the rotational speed ω, the control unit 110 calculates the back-calculated torque values T_{n,j} by using Equation (17). Subsequently, in a step S32, on the basis of the back-calculated torque values T_{n,j} and the actual torque values T_{m,j}, the control unit 110 calculates the differential torque values T_{h,j} by using Equation (18) given above. And then the control unit 110 calculates the after-filtering torque values T_{af,j} by performing filtering processing upon these differential torque values T_{h,j}.

Then in a step S33, on the basis of the limiter coefficient k, the control unit 110 calculates the feedback gains k_{p,j} by using Equation (21) given above. Subsequently, in a step S34, on the basis of the after-filtering torque values T_{af,j} and the feedback gains k_{p,j}, the control unit 110 calculates the feedback torque values T_{f,j} by using Equation (20) given above.

When the processing of the step S34 terminates, the processing of the step S14 terminates. And then the flow of control is transferred to the step S15 in FIG. 27.

As has been explained above, in the example, acquisition is performed of the movement speed v of the moving body MV having the driving wheels that are driven by the motors 930ⱼ, the rotational speeds ωⱼ of the driving wheels of the moving body MV, and the actual torque values T_{m,j} of at which the motors 930 are driven. Here, the movement speed v, the rotational speeds ωⱼ, and the actual values T_{m,j} can be acquired quickly.

Next, on the basis of the speed of movement v and the rotational speeds toₚ the control unit 110 estimates the estimated slip ratios λⱼ of the driving wheels by using Equation (5), with which quick calculation is possible. Moreover, on the basis of the rotational speeds ωⱼ and the actual torque values T_{m,j}, the control unit 110 estimates the estimated driving torques T_{d,j} of the driving wheels by using Equation (10), with which quick calculation is possible.

Next, on the basis of the estimated slip ratios λⱼ and the estimated driving torques T_{d,j}, the control unit 110 calculates the limit values Lⱼ for the torque command values T_{c,j} by using Equation (11), with which quick calculation is possible. And the control unit 110 performs limitation processing upon the torque command values T_{c,j} by using these limit values Lⱼ, and thereby calculates the limited torque values T_{L,j}.

And, in parallel with this calculation of the limited torque values T_{L,j}, on the basis of the rotational speeds ωⱼ and the actual torque values T_{m,j}, the control unit 110 successively calculates the feedback torque values T_{f,j} by using Equations (17), (18), (20), and (21) as appropriate, with which quick calculation is possible. Note that the control unit 110 calculates the feedback torque values T_{f,j} on the basis of an adhesive model.

Then, on the basis of the limited torque values T_{L,j} and the feedback torque values T_{f,j}, the control unit 10 calculates the individual torque setting values T_{s,j} according to Equation (9). Subsequently, the control unit 110 finds the minimal value among these individual torque setting values T_{s,FL} through T_{s,RR}, and sets all of the torque setting values CT_{s,FL} through T_{s,RR} to the minimal value T_{s,min} that has thus been found. And the control unit 110 sends the torque setting values CT_{s,j} that have thus been set to the minimal value T_{s,min} to the motor drive systems 900.

Therefore it is possible, according to change of the state of the road surface, rapidly to implement control for stable traveling while ensuring the required drive power.

Moreover, in the example, the torque setting values for all of the plurality of driving wheels are set to the minimal value among the individual torque setting values that have been individually calculated for each of the plurality of driving wheels. In this case, it enables to ensure stable traveling, because it enables to suppress differences of the torque setting values between the plurality of driving wheels. For example, if the vehicle is traveling upon a road surface of which only the left side of the road is frozen, then, since the torque setting value that is calculated by taking the driving wheels on the left side as subject is adapted for use with the driving wheels on the right side. Accordingly, it is possible to avoid torque unbalance between the left side and the right side, and it is therefore possible to prevent change of the orientation of the vehicle body.

### [Modification of the Example]

The present invention is not to be considered as being limited to the example described above; modifications of various kinds are possible.

For example while, in the example, it was arranged to employ an acceleration sensor when acquiring the speed of movement, it may be acceptable to arrange to employ an optical type ground sensor.

Moreover, as has been explained in connection with FIG. 26, control is performed so that the d axis detected current value I_{d,j} and the q axis detected current value I_{q,j} respectively become the same as the d axis current command value I_{d,j} and the q axis current command value I_{q,j}*. Accordingly, although there is some delay caused by the response time due to the PI calculations and the motor characteristics, as a result, the control is performed so that the actual torque value Tₘ becomes equal to the torque setting value CT_{s,j}. Due to this, while the actual torque values T_{m,j} of the motors are obtained from Equation (1) in the example, it may be acceptable to arrange to calculate the actual torque values T_{m,j} by multiplying the torque setting values CT_{s,j} by the torque response characteristic, according to the following Equation (25):

T_{m,j}=CT_{s,j}·(1/(τ₁·s+1)) (25)

Here, the value τ₁ is the time constant for torque response.

Furthermore, in the example, the traction control device does not include the error estimation part. By contrast, it may be acceptable to arrange for the traction control device to include the error estimation part.

Moreover, in the example, it was arranged to calculate the limiter coefficient on the basis of the estimated error range. By contrast, if the changes of the errors in the estimated slip ratio and the estimated driving torque are small, then it may be acceptable to arrange for the limiter coefficient to be a fixed value.

Yet further, it may be acceptable to arrange to implement a modification of the example that is similar to the change from the control part 740A to the control part 740C described above.

1-10. (canceled)

11. A traction control device for a moving body having a driving wheel that is driven by a motor, the traction control device comprising:
a movement speed acquisition part acquiring a movement speed of said moving body;
a rotational speed acquisition part acquiring a rotational speed of said driving wheel;
an actual torque value acquisition part acquiring an actual torque value generated by said motor;
a limiting part imposing limitation upon an operation of said motor on the basis of a limited torque value corresponding to a slip ratio of said driving wheel, said slip ratio being estimated on the basis of said movement speed and said rotational speed; and
a feedback part applying feedback to the operation of said motor using a feedback torque value, said feedback torque value being calculated on the basis of a back-calculated torque value and said actual torque value, said back-calculated torque value being obtained by multiplying a value obtained by differentiating said rotational speed by a characteristic value which specifies a virtual model in which slipping of said driving wheel does not occur.

12. The traction control device according to claim 11, further comprising a torque setting value calculation part that calculates a torque setting value corresponding to a torque to be generated by said motor, wherein
said limiting part comprises:
a slip ratio estimation part estimating the slip ratio of said driving wheel on the basis of said movement speed and said rotational speed;
a driving torque estimation part estimating the driving torque for said driving wheel on the basis of a value obtained by subtracting, from said actual torque value, a value obtained by multiplying a value obtained by differentiating the rotational speed of said driving wheel by the value of the moment of inertia of said driving wheel;
a limit value calculation part calculating a limit value for performing limitation processing upon the torque command value on the basis of said estimated slip ratio and said estimated driving torque; and
a limiter part, using said calculated limit value, calculating said limited torque value by performing said limitation processing upon said torque command value; and wherein:
said feedback part calculates said feedback torque value on the basis of a first subtracted value that is obtained by subtracting said back-calculated torque value from said actual torque value; and
said torque setting value calculation part calculates, as said torque setting value, a second subtracted value that is obtained by subtracting said feedback torque value from said limited torque value.

13. The traction control device according to claim 12, wherein
said limit value calculation part calculates said limit value so that, the smaller the estimated slip ratio is, the larger difference from said estimated driving torque becomes, and the larger the estimated slip ratio is, the smaller difference from said estimated driving torque becomes.

14. The traction control device according to claim 12, wherein
said limit value calculation part calculates said limit value by multiplying said estimated driving torque by a value corresponding to said estimated slip ratio.

15. The traction control device according to claim 12, wherein
said limit value calculation part calculates said limit value L according to equation (I) below, using said estimated driving torque T_{d}, said estimated slip ratio λ, and a constant p and a limiter coefficient k:
L=T_{d}·(p+k/λ) (I)

16. The traction control device according to claim 15, wherein
said limiter coefficient k is calculated according to Equation (II) below, using an estimated value a of the proportion of the lower limit value of the error range of said estimated driving torque T_{d} with respect to the true value of said driving torque, and an estimated value b of the proportion of the upper limit value of the error range of said estimated slip ratio λ with respect to the true value of said slip ratio:
k=k*·(b/a)+λ₀·((b/a)−b) (II)
here the value k* is a value of said limiter coefficient k that can provide an appropriate torque setting value, when the errors in said estimated driving torque T_{d} and said estimated slip ratio λ are small and when said limited torque value that is obtained using the limit value that is calculated according to the above Equation (I) with said constant p being set to “1” is taken as said torque setting value; and said value λ₀ is the value of the slip ratio when the friction coefficient of said driving wheel against said road surface becomes maximal.

17. The traction control device according to claim 16, wherein:
said feedback part calculates said feedback torque value by imparting a primary delay to said first subtracted value, and then multiplying it by a feedback gain kₚ; and
said feedback gain kₚ is calculated according to the following Equation (III), using a constant c that is determined in advance:
kₚ=c·k (III)

18. The traction control device according to claim 12, wherein:
the number of said driving wheels is plural; and
there is further provided a common torque value calculation part that sets the minimal value of torque setting values that have been calculated for each of said plurality of driving wheels as a common torque setting value for all of said plurality of driving wheels.

19. A traction control method that is used by a traction control device for a moving body having a driving wheel that is driven by a motor, comprising the steps of:
acquiring a movement speed of said moving body, a rotational speed of said driving wheel, and an actual torque value generated by said motor;
limiting an operation of said motor on the basis of a limited torque value corresponding to a slip ratio of said driving wheel, said slip ratio being estimated on the basis of said movement speed and said rotational speed; and
applying feedback to the operation of said motor using a feedback torque value, said feedback torque value being calculated on the basis of a back-calculated torque value and said actual torque value, said back-calculated torque value being obtained by multiplying a value obtained by differentiating said rotational speed by a characteristic value which specifies a virtual model in which slipping of said driving wheel does not occur.

20. A non-transitory computer readable medium having recorded thereon a traction control program that, when executed, causes a calculation part to execute the traction control method according to claim 19.
